(19) United States
(12) Patent Application Publication
(10) Pub. No.: US 2025/0004848 A1
(43) Pub. Date: Jan. 2, 2025

(54) DYNAMIC STEERING OF DATA-PARALLEL WORKLOADS BETWEEN ACCELERATORS

(71) Applicant: Telefonaktiebolaget LM Ericsson (publ), Stockholm (SE)

(72) Inventors: Dániel GÉHBERGER, Montreal (CA); Mohammad ABU LEBDEH, Montreal (CA); Martin JULIEN, Montreal (CA)

(73) Assignee: Telefonaktiebolaget LM Ericsson (publ), Stockholm (SE)

(21) Appl. No.: 18/292,883

(22) PCT Filed: Jul. 27, 2021
(86) PCT No.: PCT/IB2021/056829

§ 371 Date: Jan. 26, 2024

(51) Int. Cl. G06F 9/50

(52) U.S. Cl. CPC G06F 9/505

(57) ABSTRACT

A system and method determine accelerators to execute a function of an application in a computing node, where the application includes a workload steering client. The method includes receiving, by the workload steering client, a workload request from the application identifying a first task, and determining, by the workload steering client, whether the first task has an assigned accelerator. The method further includes requesting, by the workload steering client, the first task to be executed on the assigned accelerator, and returning, by the workload steering client, a result of the first task to the application.

### TECHNICAL FIELD

Embodiments relate to the field of workload management; and more specifically, to the selection of hardware accelerators for the efficient execution of applications and the functions thereof that can benefit from the use of hardware accelerators.

### BACKGROUND ART

High performance computing (HPC) refers to the field of computing where computing devices are designed for high level performance relative to the general-purpose computers available at the time. Computing devices that have been designed for HPC are sometimes referred to as ‘supercomputers.’ HPC computing devices have computing power measured often in floating point operations per second (FLOPS), where modern supercomputers can perform a hundred quadrillion FLOPS. Different architectures of processors have been used over time in HPC computing devices. The processors in these HPC computing devices have generally been uniform or general in their operation. However, use of processors of varying types and capabilities for HPC has increased. Specialized processors are referred to as accelerators or hardware accelerators.

Cloud computing is the on-demand availability of compute and storage resources in large data centers that house a large number of computer nodes connected by internal networks. Cloud computing makes these resources available without direct active management by users of the cloud computing services. The cloud computing services are often made available to users remotely via the Internet. Large clouds have functions and compute resources distributed over multiple locations. If the compute resources or functions are positioned proximate to the user and away from a centralized portion of the cloud system such resources and functions can be referred to as edge cloud services. Like HPC systems the hardware utilized by cloud systems can be varied amongst the computer nodes in the cloud system such that different types of processing capabilities are available in the form of general-purpose processors and hardware accelerators.

Hardware acceleration involves the use of specialized computer hardware to perform some functions more efficiently relative to the same functions being performed on general-purpose hardware. An example of hardware acceleration is the use of a graphics processing unit (GPU) to perform graphics functions rather than using a central processing unit (CPU). Accelerators can be hardware processing components that have efficiencies for some applications or functions relative to general purpose hardware processing components, e.g., CPUs.

Accelerators can include application specific integrated circuits (ASICs) and similar hardware components. An ASIC is designed or configured to compute a specific set of operations more efficiently than a general-purpose processor that is executing the set of operations in software. Other types of accelerators can include GPUs, functions implemented on field programmable gate arrays (FPGAs), ASICs, and similar specialized hardware components or combinations thereof. Accelerators, such as GPUs and FPGAs, are becoming increasingly popular as a part of high-performance computing and cloud systems.

Accelerators of different vendors have significant differences in hardware architecture, middleware support, and programming models. However, modern programming and execution frameworks for accelerators allow hardware accelerated applications to use different types and variants of accelerators for executing their specialized implementations. These frameworks enable the deployment and execution of the same accelerated function source code across different accelerator devices such as GPUs and FPGAs.

Hardware accelerated applications are applications with computation tasks that can be offloaded to accelerators. They consist of two main components (1) the code that runs on the general purpose processing components (e.g., CPUs) of a computing device, referred to as a compute node, and one or more functions that can be offloaded to accelerator devices. These accelerated functions can comprise highly parallel computing tasks and are referred to herein as kernels. The kernels that work well on one accelerator will not necessarily perform well on another as the kernels and the associated applications place distinct demands on accelerators, and accelerators from different vendors and of different types vary in their characteristics and performance.

### SUMMARY

In one embodiment, a method determines accelerators to execute a function of an application in a computing node, where the application includes a workload steering client. The method includes receiving, by the workload steering client, a workload request from the application identifying a first task, and determining, by the workload steering client, whether the first task has an assigned accelerator. The method further includes requesting, by the workload steering client, the first task to be executed on the assigned accelerator, and returning, by the workload steering client, a result of the first task to the application.

In another embodiment, a machine-readable medium stores therein computer program code which when executed by a computer carries out the method for determining accelerators to execute a function of an application in a computing node, where the application includes a workload steering client. The method includes receiving, by the workload steering client, a workload request from the application identifying a first task, and determining, by the workload steering client, whether the first task has an assigned accelerator. The method further includes requesting, by the workload steering client, the first task to be executed on the assigned accelerator, and returning, by the workload steering client, a result of the first task to the application.

In a further embodiment, a computing node includes a non-transitory machine-readable storage medium having stored therein, the application, the workload steering client, the workload steering agent, and the workload steering server, and a set of processors including general purpose processors and accelerators to execute the application, the workload steering client, the workload steering agent, and the workload steering server. The application, workload steering client, workload steering agent, and the workload steering server implementing the method for determining accelerators to execute a function of the application in a computing node, where the application includes the workload steering client. The method includes receiving, by the workload steering client, a workload request from the application identifying a first task, and determining, by the workload steering client, whether the first task has an assigned accelerator. The method further includes requesting, by the workload steering client, the first task to be executed on the assigned accelerator, and returning, by the workload steering client, a result of the first task to the application.

### BRIEF DESCRIPTION OF THE DRAWINGS

The embodiments may best be understood by referring to the following description and accompanying drawings that are used to illustrate embodiments. In the drawings:

FIG. 1 is a diagram of one example embodiment of an accelerated application.

FIG. 2 is a diagram of one embodiment of a dynamic workload steering service that interacts with an accelerated application.

FIG. 3 is a diagram of one embodiment of a dynamic workload steering service.

FIG. 4 is a diagram of one embodiment of interfaces between components of a dynamic workload steering service.

FIG. 5 is a diagram of the communication flows between the components of the dynamic workload steering service.

FIG. 6 is a diagram of one embodiment of a workload directives request process.

FIG. 7 is a diagram of one embodiment of a process for requesting steering directives using cached directives.

FIG. 8 is a diagram of one embodiment of a process for distributing workload steering directives.

FIG. 9 is a diagram of one embodiment of the application service subscription handling at the dynamic workload steering server.

FIG. 10 is a diagram of one embodiment of operation of the component the dynamic workload steering agent during registration.

FIG. 11 is a diagram of one embodiment of a process of the dynamic workload steering agent to provide directives to the dynamic workload steering client.

FIG. 12 is a flowchart of one embodiment of a process of a dynamic workload steering agent to process a request for steering directives.

FIG. 13 is a diagram of one embodiment of a process of a dynamic workload steering agent for handling analytics data.

FIG. 14 is a diagram of one embodiment of the components of the dynamic workload steering client.

FIG. 15 is a flowchart of one embodiment of a process of a dynamic workload steering client to handle a workload request.

FIG. 16 is a flowchart of one embodiment of a process for accelerator selection.

FIG. 17 is a diagram of one example of a cloud system in which the dynamic workload steering service can operate.

FIG. 18 is a diagram of one embodiment of a mobile communication network including resources that form an edge cloud system.

FIG. 19 is a diagram of one embodiment of a cloud system that includes edge cloud resources and centralized cloud resources.

FIG. 20A illustrates connectivity between network devices (NDs) within an exemplary network, as well as three exemplary implementations of the NDs.

FIG. 20B illustrates an exemplary way to implement a special-purpose network device.

FIG. 20C illustrates various exemplary ways in which virtual network elements (VNEs) may be coupled.

FIG. 20D illustrates a network with a single network element (NE) on each of the NDs, and within this straightforward approach contrasts a traditional distributed approach (commonly used by traditional routers) with a centralized approach for maintaining reachability and forwarding information (also called network control).

+

FIG. 20E illustrates the simple case of where each of the NDs implements a single NE, but a centralized control plane has abstracted multiple of the NEs in different NDs into (to represent) a single NE in one of the virtual network(s).

FIG. 20F illustrates a case where multiple VNEs are implemented on different NDs and are coupled to each other, and where a centralized control plane has abstracted these multiple VNEs such that they appear as a single VNE within one of the virtual networks.

FIG. 21 illustrates a general-purpose control plane device with centralized control plane (CCP) software 2150).

### DETAILED DESCRIPTION

The following description describes methods and apparatus for selecting hardware accelerators for applications and application functions. The methods and apparatus can be utilized in a dynamic workload steering services that executes in a high-performance computing (HPC), central cloud, edge cloud, and/or similar execution environments. The processes operate to manage the assignment of application workloads to the available processing resources of a hosting computer node. The assignment of application workloads can include the selection of general-purpose processors and hardware accelerators that are to execute the functions of the applications.

The embodiments provide dynamic steering of data-parallel workloads between accelerators. Accelerated applications submit requests for executing data-parallel workloads on accelerators. Each request includes information on the task (e.g., kernel) to execute, the input data, the output buffer and runtime parameters. Each request is evaluated individually to identify the most appropriate accelerator to execute the requested workload. A look-up table can be used to steer application workloads (e.g., data parallel tasks to accelerators), where kernels can be uniquely identified, and where different accelerators can be assigned depending on optional configuration parameters (e.g., class of service) and working conditions (e.g., input and output data size). Workload requests are evaluated using information on application service profiles, and workload analytics and insights data stores. While the selection and steering of functions, tasks, and kernels herein may refer to selection of ‘accelerators,’ this can also encompass general purpose processors where the general-purpose processor provides better performance. For sake of conciseness, this may nonetheless be referred to as accelerator selection.

The dynamic workload steering service can be based on three types of components: 1) a dynamic workload steering server, 2) a dynamic workload steering agent, and 3) a dynamic workload steering client. The dynamic workload steering server is mainly intended to provide interfaces with system administrators and users, for both configuration and provisioning purposes. The dynamic workload steering server is also intended to collect analytics information from the dynamic workload steering agents. The dynamic workload steering agent is mainly intended to provide the required logic for assigning accelerators to specific workloads and monitoring the accelerators of the given node. The dynamic workload steering client is mainly intended to be integrated within the applications themselves, using the steering information received from the dynamic workload steering agent to dynamically steer workloads to the assigned accelerator.

Application subscriptions are created on the dynamic workload steering server during application deployment. The dynamic workload steering client embedded into the application registers at the local “dynamic workload steering agent” that in turn verifies the subscription with the dynamic workload steering server and fetches analytics information and optimization targets.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the embodiments. It will be appreciated, however, by one skilled in the art that the embodiments may be practiced without such specific details. In other instances, control structures, gate level circuits and full software instruction sequences have not been shown in detail in order not to obscure the embodiments. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Parallel computing involves the execution of different functions or components of an application in parallel using different compute resources in cloud computing environments (i.e., on cloud systems) or HPC system. Parallel computing is enabled by the availability of multi-core central processing units (CPUs) and accelerators (e.g., graphics processing units (GPU) and field programmable gate arrays (FPGA)). Accelerators as used herein are special-purpose processing devices designed to speed up parallel and compute-intensive aspects of the applications. Accelerators are becoming increasingly popular means to assist the general-purpose processors (i.e., CPUs) in running applications by offloading complex and intensive computational functions (or tasks) to run on these accelerators. The applications that have computation functions or tasks that can be offloaded to accelerators are referred to herein as hardware accelerated applications. The hardware accelerated applications, referred to herein interchangeably as accelerated applications and hardware accelerated applications, consist of two main components (1) the code that runs on the host computer (i.e., on the compute node), and (2) one or more functions that can be offloaded to accelerators. These functions that can be offloaded to accelerators often include highly parallel computing tasks and are referred to herein as kernels.

The compute nodes of mobile network infrastructure and similar or related infrastructure such as central cloud or edge cloud computing are highly heterogeneous (e.g., different models of CPU, GPU, and FPGAs from various vendors can be present). The availability of highly heterogeneous compute nodes creates the problem of selecting the best available compute resources on a compute node to run a given kernel in an application, such that the end-user's intention for the efficient execution of the application and its functions is fulfilled. The problem becomes more challenging when taking into consideration that the selection might need to be updated when the application's workload and/or the number of applications on the compute node are changed. One approach when deploying accelerated applications on compute nodes (e.g., in cloud systems) is to ask the application providers to provide information that specifies the accelerator to allocate to the application for hardware acceleration purposes. For instance, a cloud or edge cloud system implementing Kubernetes for container management can require that the developer of an application to be deployed specifies the accelerators to be used for different containers (or Pods) in the manifest file.

Different types of selection algorithms (e.g., greedy, machine learning, and similar algorithms) can be utilized to dynamically select where to execute a kernel (i.e., an application function) in order to optimize the execution of the kernel. These selection algorithms can have different aims. For instance, some selection algorithms aim at optimizing execution time for assigned kernels. Other selection algorithms aim to automatically distribute the kernels between general purpose processors (e.g., CPUs) and accelerators (e.g., GPUs) based on the execution time of the kernels on each type of processor. Further, some selection algorithms analyze the application code and extract application features that can be used by a machine learning model to decide where to run the kernel. In one example, an OpenCL kernel scheduling algorithm can be used to schedule kernels from multiple applications on CPUs or GPUs. This algorithm utilizes a model to predict the performance of the kernel on a certain device from its static code structure so that kernels are assigned to the devices (i.e., accelerators) likely to provide the best performance for that kernel. In another example, an adaptive scheduling technique for integrated CPU-GPU processors performs online profiling of the kernel on each device to decide how to distribute the workload between the CPU and GPU. Other selection algorithms can have the aim to optimize energy consumption. For example, a CPU-GPU utilization aware and energy-efficient algorithm can utilize an energy consumption model. In another example, a task scheduling scheme optimizes the overall energy consumption of the system by effectively adjusting the schedule based on the acceleration factor.

The development frameworks of accelerated applications can support developers to write kernels that execute across heterogeneous platforms consisting of CPUs and different types of accelerators such as GPUs and FPGAs. However, existing cloud management systems cannot harness the power of kernels' execution flexibility and portability enabled by these frameworks. When an accelerated application is deployed, application developers can preconfigure the applications and statically define where each kernel in an application is to be executed in order to meet a desired objective (e.g., improving performance and minimizing energy consumption). However, this approach limits the autonomy of the cloud management systems to select the most suitable hardware accelerators autonomously. It provides a rigid and static workload steering that does not take into consideration the dynamicity of the execution environment (e.g., workload pattern) which may lead to suboptimality of the initial device selection to run a certain kernel. The embodiments provide dynamic workload steering that are not limited to algorithms that seek to satisfy different specific objectives (e.g., minimizing energy consumption) by dynamically selecting suitable hardware accelerators to execute a kernel. The embodiments provide a cloud application management system that can take advantage of these selection algorithms to support the dynamic workload steering of kernels.

The embodiments provide a dynamic workload steering service, a system and method for automatically distributing data parallel compute tasks in a cloud execution environment equipped with a heterogenous set of hardware accelerator devices. The dynamic workload steering service can include a server, an agent, and a client component. The server handles the central coordination, application subscriptions and optimization of targets. The agent acts as a local coordinator at the computing node that collects analytics information and issues steering commands towards the clients that are embedded inside user applications. Analytics information and insights are collected centrally by the server from all agents, thus ensuring workload steering directives can be more optimal over time.

The system and method for dynamic workload steering with central coordination provides advantages including real-time workload steering between accelerators using collected analytics and insights, centrally collected and merged analytics information and application insights that can be re-used for subsequent application deployments. The embodiments also support central collection of data for machine learning based steering algorithms. The embodiments provide a system and method for enabling dynamic steering of data parallel workloads in heterogenous environments. The embodiments of the dynamic workload steering component encompass several components. The embodiments also define internal and external interfaces and exchanged messages for these components. The embodiments further provide internal components, algorithms, and data collection. The embodiments also provide a description and an example of an accelerator selection process. Example embodiments are also provided for distributed or cloud systems implementing the dynamic workload.

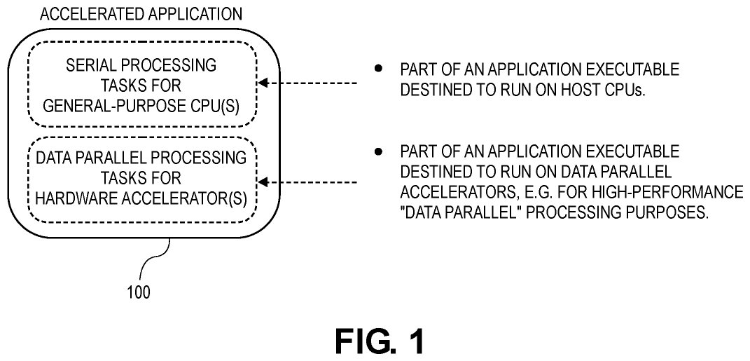

FIG. 1 is a diagram of one example embodiment of an accelerated application. The example accelerated application 100 includes serial logic and data-parallel logic, where the serial logic can be most efficiently executed on general purpose processors and the data-parallel logic can be most efficiently executed on certain hardware accelerators. In the embodiments, the accelerated application 100 is designed such that the compute-intensive tasks or functions, such as those tasks or functions requiring massive data-parallel processing capacity, can be offloaded to specialized hardware accelerators, such as GPUs, FPGAs, AI processing units, and similar accelerators.

General purpose processors (e.g., CPUs) can be utilized to execute the serial portion of application logic, whereas accelerators are more suited to execute the data-parallel portion (i.e., the kernel) of their processing logic. Accelerated applications 100 have their generic processing (e.g., the serial logic) tasks executed on general purpose processors (e.g., CPUs). The more specialized and compute-intensive tasks are executed on hardware accelerators for faster and more efficient execution since the accelerators can offer better data-parallel processing.

Different accelerated applications 100 can implement different kernels that have varied levels of complexity, parallelism, resource usage patterns, and similar characteristics and can be developed for specific types of accelerators. The embodiments provide kernel ‘insights,’ related to an application's capacity to offload its data-parallel processing tasks to hardware accelerators, that can improve the selection process for accelerated applications 100 with respect to the selection and allocation of hardware accelerators onto cloud infrastructures. The kernel insights can contribute to enhancing both application performance and overall cloud system efficiency.

The ‘insights’ as used herein refers to data embedded in an application 100 that provides information about the characteristics of the associated kernel that can inform an orchestrator of a cloud system as to the optimal accelerator that can be utilized from a set of available accelerators at run time. A ‘set,’ as used herein refers to any positive whole number of items including one item. The insights would be embedded directly within the generated accelerated application standalone executable. The embedded insights would be accessible using runtime application programming interfaces (APIs), and/or using specialized utility applications. The insights-based accelerator selection can improve predictions of the performance of accelerated applications on different accelerators, contributing to the allocation of the most appropriate accelerator, at deployment time, to each accelerated application by the cloud orchestration system.

Embedding kernel insights within accelerated application 100 executables can provide advantages including providing a set of kernel insights within accelerated applications 100 executables, which (1) are independent of any externally provided set of information, (2) have certification from the application developers, (3) are generated from privileged accesses to applications' source code during the development environment phase, and (4) can be standardized on a specification of kernel insights, from the definition of insights to their secured access.

Depending on development and execution environments, different solutions (i.e., different formats, organization, contents) for embedding insights within an accelerated application can be used. In the embodiments, embedding insights within an accelerated application provides the capacity to keep kernel insights within an accelerated application 100 deliverable for execution on a cloud system infrastructure.

In cloud orchestration systems, such as OpenStack and Kubernetes, support is provided to embed information directly within standalone executable packages. The cloud orchestration systems have embedded information in the execution packages to specify an execution context required for running the application, e.g., by embedding the deployment information within the standalone application executable package.

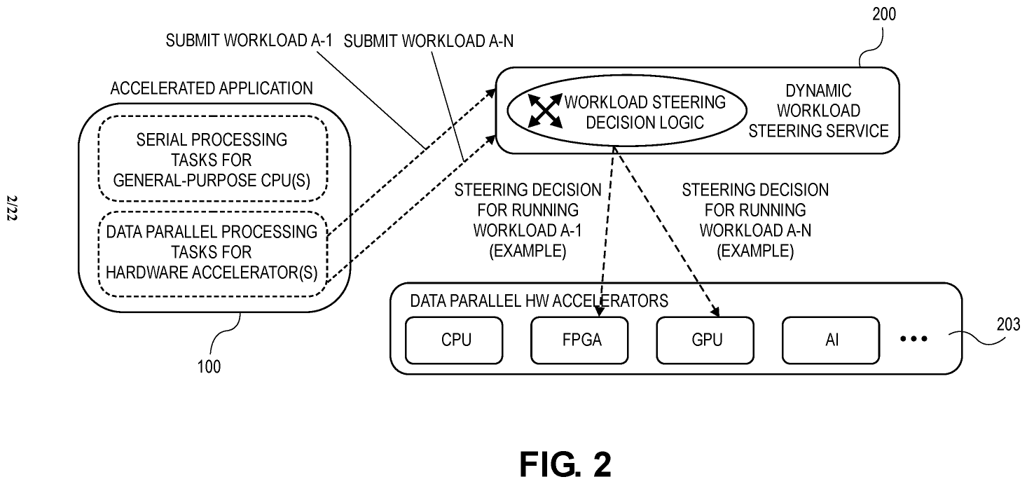

FIG. 2 is a diagram of one embodiment of a dynamic workload steering service that interacts with an accelerated application. The dynamic workload steering service 200 selects the most appropriate accelerator 203 for each submitted parallel execution task. In the embodiments, the data parallel tasks are created in a way that they can be executed on different accelerators 203 (e.g., GPU or FPGA). There are multiple possible ways to select the accelerator to be utilized for a kernel. The selection can utilize the properties of OneAPI that enables running the same code on multiple accelerators. In some embodiments, different implementations of the same data parallel algorithm using accelerator specific tools and a common API can be utilized. A general-purpose processor (e.g., a CPU) is used for the execution of the serial processing task but can also be treated as an accelerator in some configurations. Some general-purpose processors, especially modern server-grade CPUs, are equipped with a large number of cores (e.g., around 40 cores in some servers). Data parallel frameworks can utilize the CPU cores to distribute the tasks, similarly on CPUs as it is done on GPUs and other accelerators 203.

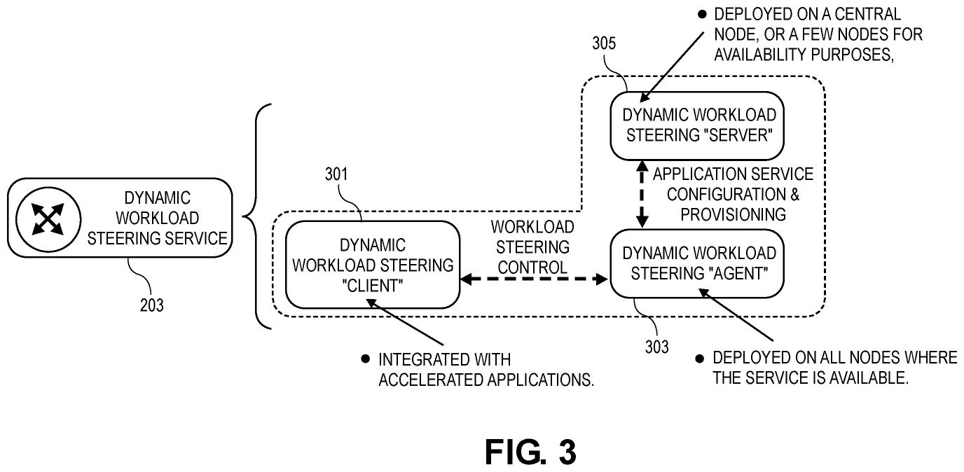

FIG. 3 is a diagram of one embodiment of a dynamic workload steering service. The dynamic workload steering service 203 is composed of multiple functional blocks along with the internal interfaces. The steering of workloads is centrally coordinated from the dynamic workload steering server 305 that is deployed on one or possibly a few computing nodes for availability purposes. A dynamic workload steering service agent 303 is deployed on all nodes (e.g., physical servers) where the dynamic workload steering service 203 is available. The dynamic workload steering server 305 provides service configuration and provisioning for the dynamic workload steering agent 303, but the dynamic workload steering agent 303 handles the local steering decisions according to load and monitoring information. The dynamic workload steering client 301 is integrated with the accelerated application 100. The task of the dynamic workload steering client 301 is to manage the execution of the data parallel tasks on the available accelerator devices based on the steering control commands received from the dynamic workload steering agent 303.

In some embodiments, the interface between the dynamic workload steering server 305 and the dynamic workload steering agent 303 can be lightly used without strong performance requirements, e.g., hypertext transfer protocol (HTTP) representational state transfer (REST) can be used for communication between the dynamic workload steering server 305 and the dynamic workload steering agent 303. In some embodiments, the interface between the dynamic workload steering client 301 and the dynamic workload steering agent 303 can be also realized with HTTP REST. In other embodiments, the interface between the dynamic workload steering client 301 and the dynamic workload steering agent can have stricter tolerances on latency and similar performance metrics and a lower latency or higher bandwidth interface (e.g., shared memory based) solution can be utilized.

The dynamic workload steering server can be deployed at a central computing node or multiple instances of the dynamic workload steering server can be deployed at multiple computing nodes to reduce latency and increase availability. The dynamic workload steering agent can be deployed to all computing nodes where the dynamic workload steering services are to be offered and supported. The dynamic workload steering agents can communicate with and take direction from the dynamic workload steering server that has the lowest latency, closest distance, or selected on similar metrics of characteristics in cases where there are more than one instance of the dynamic workload steering server available.

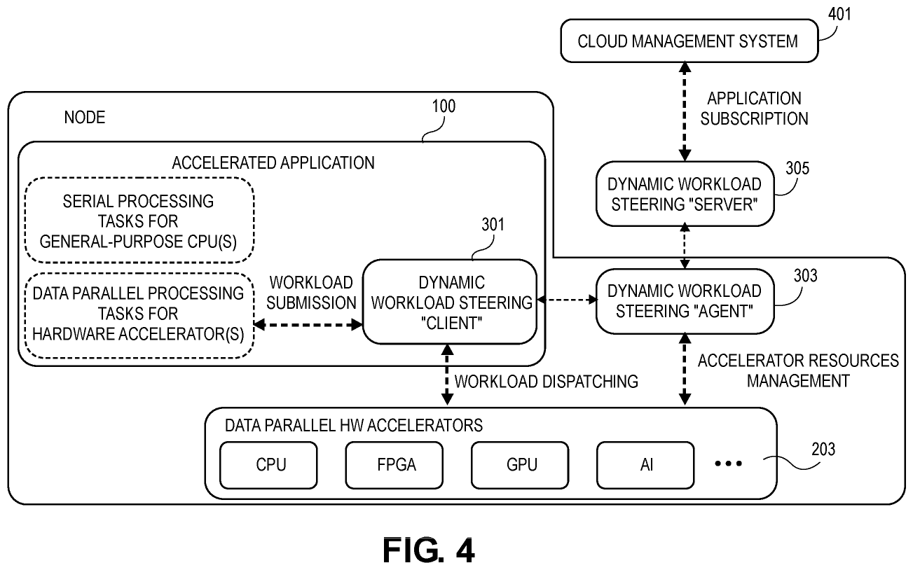

FIG. 4 is a diagram of one embodiment of interfaces between components of a dynamic workload steering service. The dynamic workload steering service has internal connections between components and is connected to multiple external components. The central cloud management system 401 communicates with the dynamic workload steering service server component to configure application subscriptions. Application subscriptions are relationships between the dynamic workload steering agents and servers that are tracked and managed for purposes of configuration. On a computing node level, the task of the dynamic workload steering agent is to discover, manage and monitor the underlying available accelerator devices 301. The dynamic workload steering client takes data parallel workload submissions and dispatches the requests to the accelerators according to the steering policies provided by the dynamic workload steering agent.

The dynamic workload steering client 301 is part of an accelerated application 100. In some embodiments, the dynamic workload steering client 301 can be implemented as a software library that is linked to the accelerated application. The dynamic workload steering client 301 offers a software application programming interface (API) towards the accelerated application 100 that can be used for workload submission requests.

The dynamic workload serving client 301 and the dynamic workload serving agent 303 work together to discover available hardware accelerators 203 and assign workload submission requests to these hardware accelerators 203. The dynamic workload steering agent 303 is assumed to be able to access and monitor all accelerators 203 at the respective computing node. The dynamic workload steering client 301 may only be provided a restricted set of accelerators depending on the deployment and the permissions of the accelerated application 100. For example, if a computing node is equipped with CPU, FPGA and GPU and the accelerated application runs inside a container, the container may have access to a specific set of cores of the CPU and the GPU only.

The dynamic workload steering agent 303 can receive or collect accelerator resource management information from the available processors. This information can be collected using any protocol or technology available in the execution environment of the computing node. The accelerator resource management information can have any format and can include any set of metrics or characteristics related to the available hardware accelerators and general-purpose processors. The accelerator resource management information can be obtained via a hypervisor, operating system, or similar resource management software of the computing node. The dynamic workload steering client 301 can dispatch workloads (i.e., kernels, functions, or tasks) of the accelerated applications 100 to be executed by the accelerators selected by the associated dynamic workload steering agent 303. The workload dispatching can use any protocol, technology, software library, or API to interface between the dynamic workload steering client 301 and the hardware accelerators 203 including calls to the operating system, hypervisor, container management or orchestrator, or similar components of the computing node.

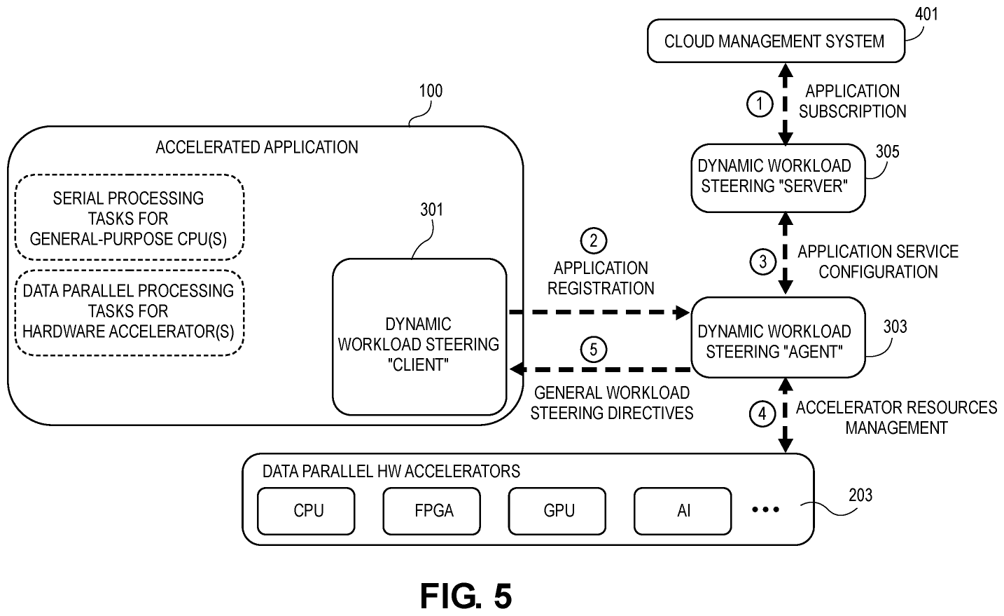

FIG. 5 is a diagram of the communication flows between the components of the dynamic workload steering service. The communication between components of the dynamic workload steering service can be categorized into two types of the registration, depicted in FIG. 5, and the workload steering related steps described in relation to subsequent figures herein. Any discovery mechanism, handshaking, or similar technologies or combinations thereof for establishing connections between the components can be utilized.

The registration process can be triggered when the cloud management system 401 receives a new request to deploy an accelerated application. In the first step, the cloud management system creates an application service subscription. This step notifies the dynamic workload steering server 305 component about the details of the accelerated application. For example, once an accelerated application for handling image recognition is onboarded into the cloud system, the dynamic workload steering server 305 is notified, possibly along with several meta information components, about the application 100. The notification can include static insights about the application 100 and optimization targets. Parts of the application subscription might be updated by the cloud management system at a latter point in time, e.g., in case of a change in optimization targets.

Once an accelerated application 100 instance is deployed, the embedded dynamic workload steering client 301 registers, at step (2), at the local dynamic workload steering agent 303. In some embodiments, the discovery mechanism between the dynamic workload steering client and the dynamic workload steering agent is implementation independent of the registration process. For example, the discovery mechanism or similar connection establishment process can be based on a configuration of the dynamic workload steering client, a well-known address for the dynamic workload steering agent, or a shared file location. The dynamic workload steering agent confirms the registration of the dynamic workload steering client with the dynamic workload steering server at step (3). The dynamic workload steering server requests relevant insights and optimization targets from the dynamic workload serving client 301, agent 303, and/or cloud management system 401. The dynamic workload steering agent 303 also discovers available hardware accelerators and configures monitoring of these hardware accelerators at step (4) using accelerator resource management.

The dynamic workload steering agent 303 sends initial steering directives to the dynamic workload steering client at step (5). During the registration, a unique registration identifier (ID) can be created that is used for future communication with the dynamic workload steering client. The initial directives to the dynamic workload steering client by the dynamic workload steering service ensure that if for any reason the dynamic workload steering agent is not available, the dynamic workload steering client can continue dispatching data parallel tasks. As an example, the dynamic workload steering agent may instruct the dynamic workload steering client to use only a specific GPU or set of GPUs in this fallback case.

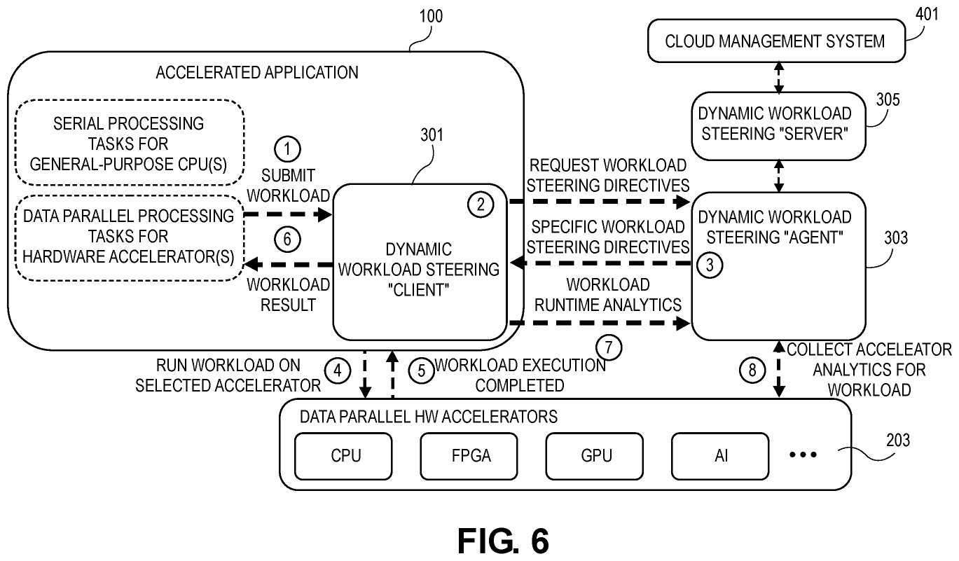

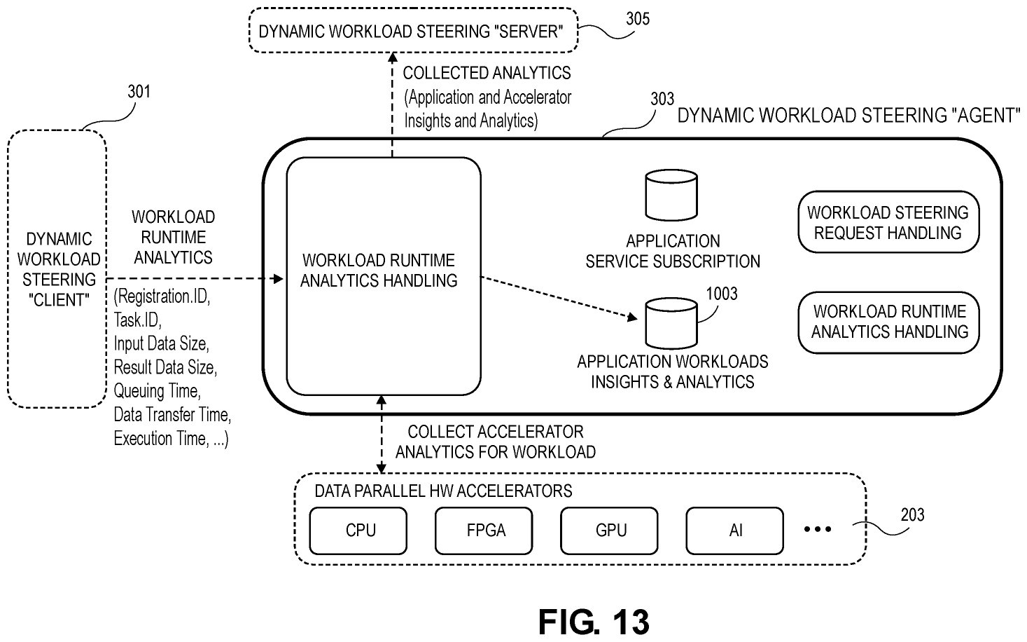

FIG. 6 is a diagram of one embodiment of a workload directives request process. After registration, the dynamic workload steering client 301 can start receiving workload submission requests from the accelerated application 100. The accelerated application 100 submits the task to the dynamic workload steering client at step (1). The dynamic workload steering client 301, in response, requests steering directives from the dynamic workload steering agent 303 of the computing node where the accelerated application 100 is executing, at step (2). The dynamic workload steering agent 303 uses workload steering algorithms and policies to decide on which processor or set of processors to run the task and sends back the directives to the dynamic workload steering client at step (3). The dynamic workload steering agent 303 process for selecting where the task will be executed is described herein with relation to FIG. 13.

Continuing with FIG. 6, after the directives are received at the dynamic workload steering client 301, the dynamic workload steering client 301 sends the task to the selected accelerator device to be executed at step (4). After finishing the task execution, the dynamic workload steering client 301 receives confirmation or notification of completion from the hardware accelerators 203 at step (5). The dynamic workload steering client 301 reports the results to the application at step (6) and sends runtime analytics information to the dynamic workload steering agent 303 at step (7) that is used together with additional collected analytics, collected at step (8), for future steering decision making at the dynamic workload steering agent 303.

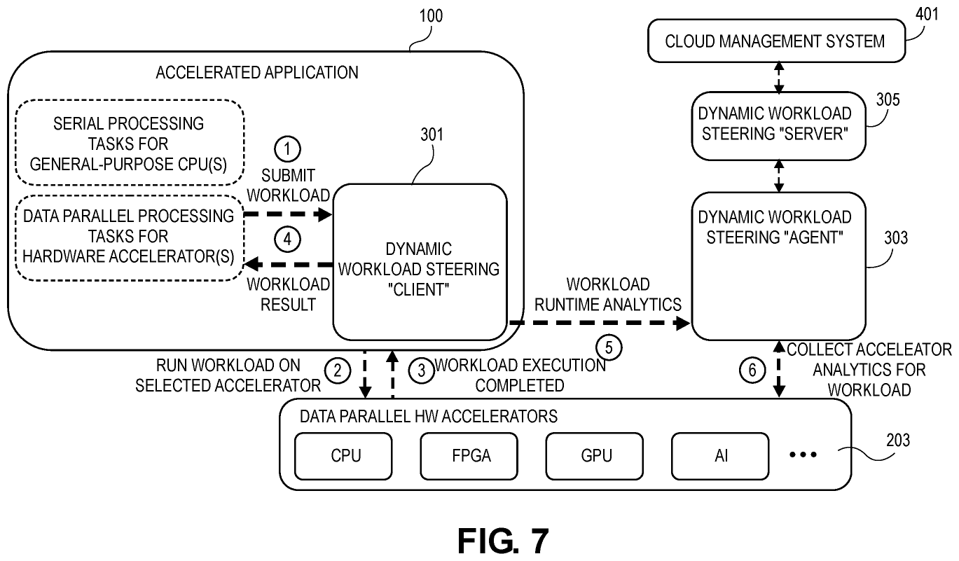

FIG. 7 is a diagram of one embodiment of a process for requesting steering directives using cached directives. Sending a request to the dynamic workload steering agent 303 for each workload submission can cause a performance bottleneck even if a low-latency communication method is applied between the dynamic workload steering client 301 and the dynamic workload steering agent 303. The dynamic workload steering agent 303 can provide cached directives either during the registration process, via an unsolicited update, or using similar mechanisms.

The dynamic workload steering client 301 can handle the workload submissions without communicating with the dynamic workload steering agent 303 (i.e., using the cached directives). After that, it sends runtime analytics information to the dynamic workload steering agent 303. The dynamic workload steering client 301 may also batch multiple analytics reports further lowering the communication overhead. In the illustrated example, the process involving cached directives can be triggered in response to a workload submission request received at the dynamic workload steering client, at step (1). The dynamic workload steering client 301 then applies directives and policies previously received or a specific accelerator assignment per kernel or task and stored locally in a cache to the submission request to then assign the workload to a selected accelerator at step (2). Once the workload completes, as indicated by a notice from the hardware accelerators 203 at step (3), the result of the workload execution is returned as a result to the accelerated application 100 at step (4). Asynchronously or after each completion the dynamic workload steering client 301 can report the runtime analytics to the dynamic workload steering agent 303, at step (5). The dynamic workload steering agent 303 can similarly asynchronously collect the accelerator analytics at step (6).

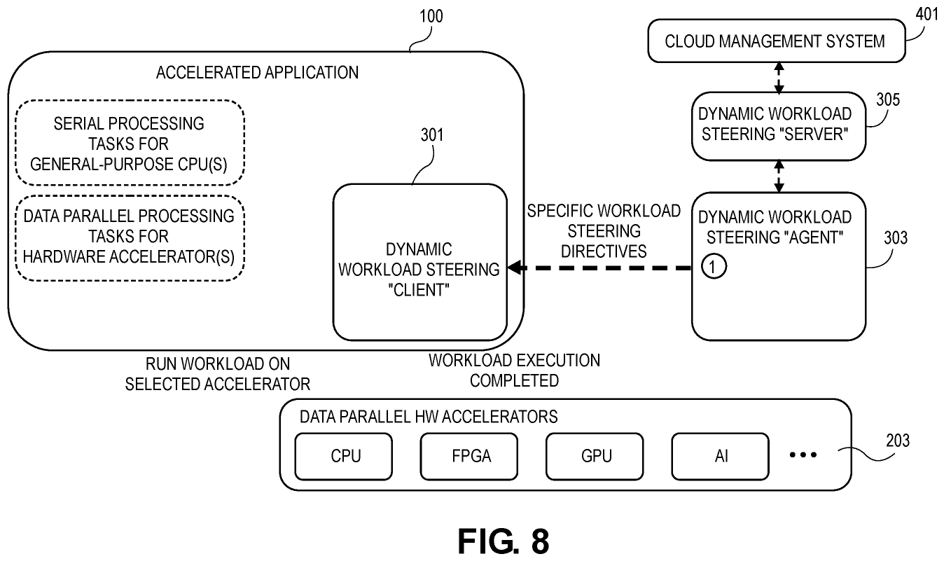

FIG. 8 is a diagram of one embodiment of a process for distributing workload steering directives. The diagram illustrates a workload steering operation with cached directives in the dynamic workload steering client 301. In this embodiment, the dynamic workload steering agent 303 provides the cached directives using unsolicited updates that are sent by the workload steering agent 303 whenever there is an update to the workload steering directives for the accelerated application 100, on a periodic basis, or under similar circumstances.

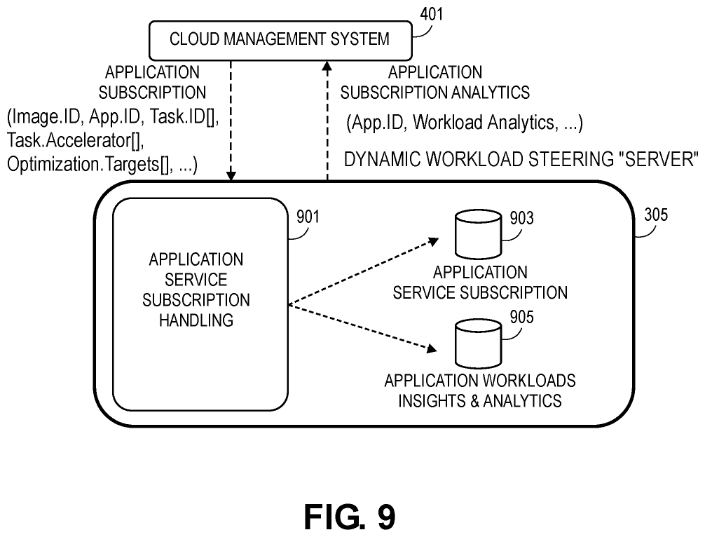

FIG. 9 is a diagram of one embodiment of the application service subscription handling at the dynamic workload steering server 305. The dynamic workload steering server 305 receives meta information as part of an application subscription received from the cloud management system 401. The meta information contains a unique ID (e.g., an App.ID) that is also used by the accelerated application 100 in the registration process and optimization targets for the application. Optimization targets are goals for accelerator selection that may include for example optimizing for high-performance, low power consumption, and similar targets. These optimization targets can also include a weighted relation between the individual parameters. The meta information also contains an Image. ID that identifies the software image (e.g., Docker container) used by the accelerated application 100. Different deployments of the same image (i.e., different instances of an accelerated application) are subscribed with different App.IDs. The same data parallel tasks will be present in different instances of the same image, thus enabling broader data collection, while the optimization targets can be different for each deployment (App.ID).

The different data parallel tasks of applications need to be identified to enable collection of per task analytics information and the per-task accelerator assignment decisions. Multiple different solutions may be applied for the identification of data parallel tasks that ensure that the same data parallel task is consistently marked with the same identification for each workload submission. In some embodiments, the unique identification of different tasks can be maintained across application deployments, i.e., the same accelerated application 100 deployed on multiple nodes. One possible solution for this is using unique IDs for data parallel tasks that are created during compilation of the application. In some embodiments, the task identification information can also be provided as part of the meta information when the application subscription is created.

In some embodiments, optimization targets can be defined for individual data parallel tasks, e.g., setting priorities or identifying performance critical components using the individual identifiers for the tasks. Furthermore, the complexity (e.g., number of loops, memory operations) for each data parallel task might be provided to be used for the accelerator assignment process.

In a further embodiment, the list of data parallel tasks can be discovered through normal operation via the workload submissions. The dynamic workload steering client 301 may use e.g., a hash function to consistently create a unique identifier for data parallel tasks. This solution is simpler, but less flexible. The example embodiments described herein utilize the unique identifier where the data parallel tasks are identified as part of the meta information provided in the application subscription, rather than through a discover process by way of example and not limitation and for sake of clarity and conciseness.

In one example embodiment, the same accelerated application 100 is deployed on multiple nodes served by different local dynamic workload steering agents 303. It is the task of the dynamic workload steering server 305 to collect analytics information from all dynamic workload steering agents 303 and create a unified view regarding the execution of the accelerate applications. This unified view then can be distributed among the dynamic workload steering agents 303 for better decision making.

The dynamic workload steering server 305 can provide analytics information towards the cloud management system 401 for monitoring and verification purposes (Block 401). The dynamic workload steering server 305 internally keeps multiple data stores. An application service subscription store 903 is used to store the subscription information provided by the cloud management system 401. An application workloads insights and analytics store 905 is used to store the run-time metrics of the tasks collected from the dynamic workload steering agents. The application workloads insights and analysis store 905 contains data for all data parallel tasks (belonging to accelerated applications 100) for the different accelerators available in the system. The task of the dynamic workload steering server 305 is to collect data from the dynamic workload steering agents 303 and create a unified view. For example, if one computing node has only a GPU and another computing node only an FPGA, while the local dynamic workload steering agents 303 can only collect partial analytics information, the dynamic workload steering server 305 will store data for both the GPU and the FPGA enabling a comparison of the performance of each of these accelerators.

Collected analytics can also be shared with the cloud management system 401 in addition to the sharing of the analytics with the dynamic workload sharing agents 303. The data shared with the cloud management system 401 in the form of application subscription analytics that include App.ID correlated with workload analytics.

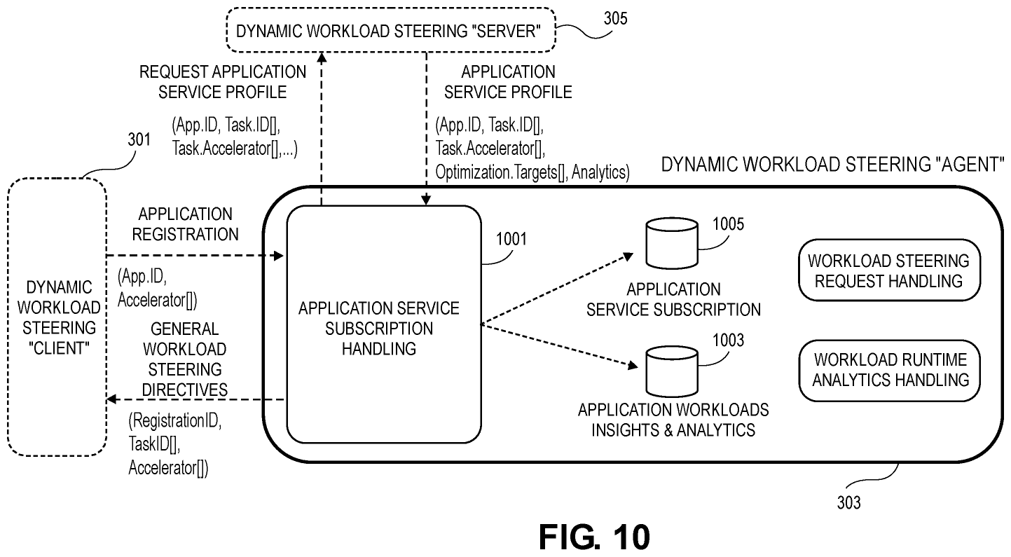

FIG. 10 is a diagram of one embodiment of operation of the component the dynamic workload steering agent 303 during registration. The internals of the dynamic workload steering agent 303 and some of the exchanged parameters during the application registration and workload steering are illustrated. The accelerated application registers at the dynamic workload steering agent 303 via its embedded dynamic workload steering client 301. The accelerated application is identified with its unique ID (App.ID) and the list of available accelerators is also provided in return. Upon receiving a registration, the dynamic workload steering agent 303 sends a request to the dynamic workload steering server 305 to get subscription information for the application. If the application has a subscription, the dynamic workload steering server 305 provides the defined optimization targets, list of data parallel tasks (if available), and the historical collected analytics information for the listed accelerators in the response as an application service profile. The dynamic workload steering server 305 can provide analytics information for the listed accelerators collected during the monitoring of other instances of the accelerated applications.

As the figure shows, the dynamic workload steering agent 303 uses the same kind of data stores as the dynamic workload steering server 305 to store information related to its registered accelerated applications, namely the application service subscription store 1005 and the application workload insights and analytics store 1003, which each operate in the same manner as the equivalent stores at the dynamic workload steering server 305.

The dynamic workload steering agent 303 provides a registration ID that is created and sent to the dynamic workload steering client 301 as part of the general workload steering directives. The registration ID is sent along with directives in the form of the taskID and selected accelerator tuples or similar correlations. The registration ID serves to identify particular sets of directives sent by the dynamic workload steering agent 303.

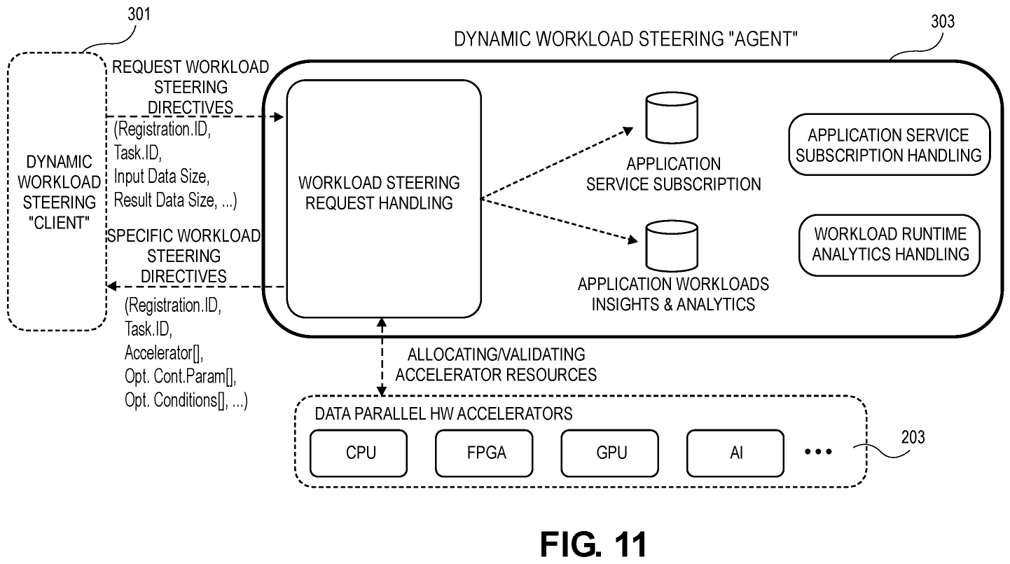

FIG. 11 is a diagram of one embodiment of a process of the dynamic workload steering agent 303 to provide directives to the dynamic workload steering client 301. The process shows the information exchanged once the dynamic workload steering client 301 requests workload steering directives. As it can be seen details about the given data parallel task are submitted for example input and output data size. The dynamic workload steering agent 303 then creates a steering directive using configured optimization targets, collected analytics and available accelerators. The specific workload steering directives for the given task are then transmitted to the dynamic workload steering client 301.

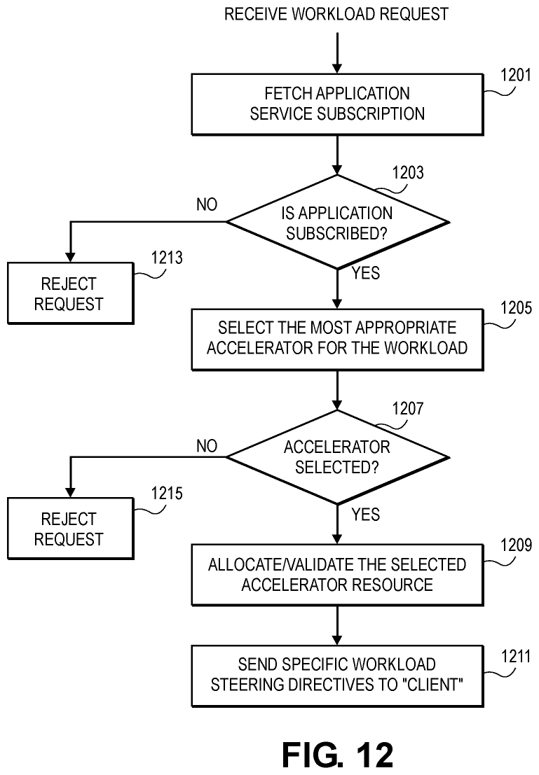

FIG. 12 is a flowchart of one embodiment of a process of a dynamic workload steering agent 303 to process a request for steering directives. The dynamic workload steering agent 303 receives a workload request from the dynamic workload steering client 301 (Block 1201). The dynamic workload steering agent 303 determines whether the accelerated application associated with the request is subscribed (Block 1203). If the accelerated application is not subscribed, then the request is rejected, and no directives are returned to the accelerated application (Block 1213). The application subscription is determined by a lookup of the registration ID or similar application identifier in the application service subscription store. If an application subscription exists, then the dynamic workload steering agent 303 can select the most appropriate accelerator for the workload (Block 1205). The most appropriate accelerator can be determined based on analytics for each accelerator collected by the dynamic workload steering agent 303 from the accelerators and general-purpose processors as well as received from the dynamic workload steering server 305. The best performing accelerator for an optimization target can be selected from the accelerators available on the computing node.

If an accelerator is found with analytic performance metrics that meet a threshold quality for the optimization target, then the dynamic workload steering agent 303 can allocate and/or validate the selected accelerator to ensure its availability and capacities (Block 1209). The allocated and/or validated dynamic workload steering directives can then be sent to the dynamic workload steering client 301 (Block 1211). If no accelerator is found that meets a threshold for quality in meeting an optimization target, then the workload request can be rejected, or another process can be invoked to select an accelerator (e.g., using a default specified by the application).

FIG. 13 is a diagram of one embodiment of a process of a dynamic workload steering agent for handling analytics data. Analytics information is collected both from the dynamic workload steering client 301 and directly from the accelerators 203. After execution of a data parallel task, the dynamic workload steering client 301 reports analytics e.g., timing and queueing information related to the task. The dynamic workload steering client 301 can report analytics in batches instead of each individual execution. The dynamic workload steering agent 303 also provides analytics updates towards the dynamic workload steering server 305 for unified view creation across multiple computing nodes and dynamic workload steering agents 303. The analytics collected from the dynamic workload steering client 303 and the analytics collected directly from the accelerators and general-purpose processors 203 can be stored in the application workload insights and analytics store 1003.

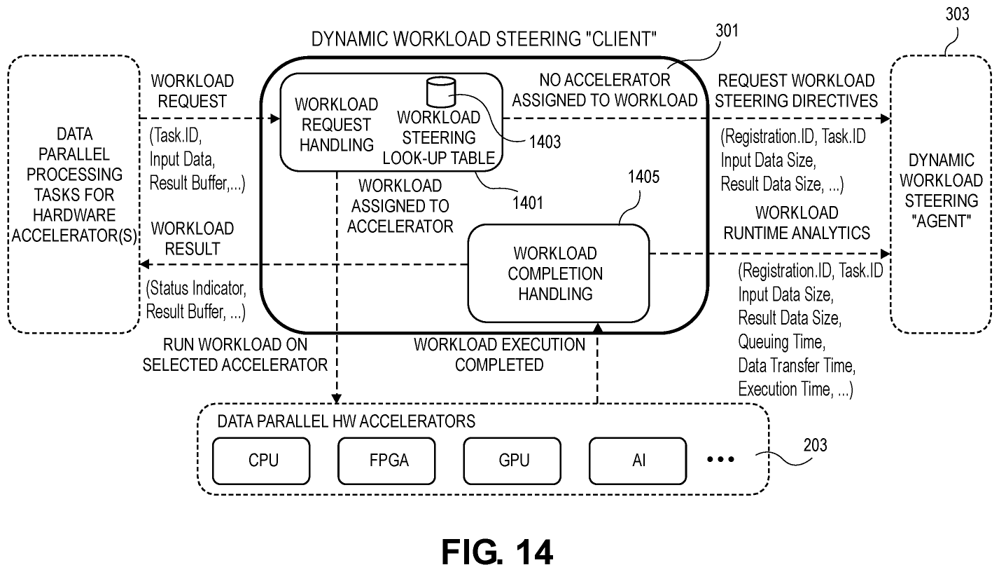

FIG. 14 is a diagram of one embodiment of the components of the dynamic workload steering client 301. The dynamic workload steering client interactions between the components are also illustrated. The accelerated application uses the API of the dynamic workload steering client 301 to execute data parallel tasks and get results for these tasks. In particular, the data parallel processing tasks or similar functions, which can be in the form of kernels, can generate workload requests that include a task ID, input data, a result buffer, and similar parameters. The workload request handling component 1401 perform a lookup using the input task ID and similar information to identify an entry in a workload steering lookup table 1403 in the dynamic workload steering client 301. If an entry is found with a selected accelerator, then the workload is assigned to that accelerator in the set of hardware accelerators and general-purpose processors. If no accelerator assignment is found in the lookup table, then a request is sent to obtain workload steering directives from the dynamic workload steering agent 303.

The dynamic workload steering client 301 can provide workload runtime analytics upon completion of a workload by the hardware accelerators or general-purpose processors 203 to the dynamic workload steering agent 303. The workload runtime analytics can include registration ID, task ID, input data size, result data size, queuing time, data transfer time, execution time, and similar metrics and analytics. Similarly, upon completion of a workload, the workload completion handling component 1405 can send a workload result to the accelerated application or the requesting task or function thereof including a status indicator, result buffer, and similar information.

In some embodiments the dynamic workload steering client 301 includes a look-up table 1403. The lookup table 1403 is populated with workload steering entries from the dynamic workload steering agent 303. The table can be populated on-demand, by sending a request for directives for unknown data parallel tasks. The lookup table 1403 can be also updated by the dynamic workload steering agent 303 asynchronous to any request for directives.

Table I is an example look-up table in the dynamic workload steering client 301. The entries regarding the specific data-parallel tasks are added to the table based on the communication with the dynamic workload steering agent 303. Tasks can be assigned to accelerators under certain conditions. For example, Task A is assigned to Accelerator A if the sizes of the input and output data are less than 1 KB, but to Accelerator B otherwise. The table can also record optional parameters like Class of Service that is passed to the selected accelerator upon invocation. The table may also indicate to use the CPU, rather than a specialized Accelerator.

TABLE I

| | Look-Up Table Result | | |
|---|---|---|---|
| Look-Up | | Optional | |
| TABLE Key | Accelerator (e.g., | Configuration | Optional |
| Task ID | Device Queue) | Parameter(s) | Condition(s) |
| Task A | Accelerator A | Class of Service | Input Data Size: |
| | (e.g., FPGA) | (0-7): (e.g., 1) | (e.g., <=1 kB) |
| | | . . . | Result Data Size: |
| | | | (e.g., <=1 kB) |
| | Accelerator B | Class of Service | Input Data Size: |
| | (e.g., GPU) | (0-7): (e.g., 1) | (e.g., >1 kB) |
| | | . . . | Result Data Size: |
| | | | (e.g., N/A) |
| Task B | Accelerator B | Class of Service | Queue Occupancy: |
| | (e.g., GPU) | (0-7): (e.g., 3) | (e.g., <10%) |
| | | | . . . |
| | No Accelerator | — | Queue Occupancy: |
| | | | (e.g., N/A) |
| | | | . . . |
| . . . | | | |

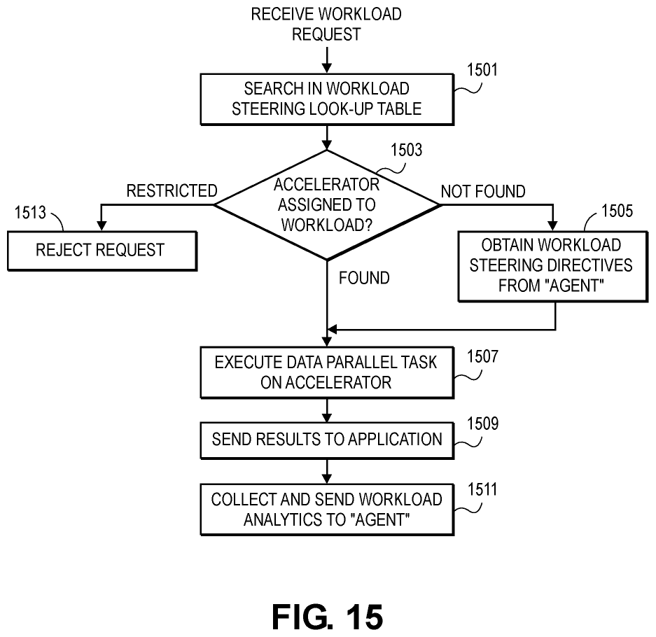

FIG. 15 is a flowchart of one embodiment of a process of a dynamic workload steering client 301 to handle a workload request. If the dynamic workload steering client 301 is not using the look-up table the flow stays the same, but the dynamic workload steering client 301 can obtain the steering directives for every request from the dynamic workload steering agent 303, rather than the lookup table or similar local cache.

This process of the dynamic workload steering client 301 can be triggered by receiving a workload request from a task, function, kernel, or similar component of an accelerated application (Block 1501). The workload handling component of the dynamic workload steering client 301 can perform a lookup or similar search of the lookup table or similar local cache of directives from the dynamic workload steering agent 303. If an accelerator is not found in the lookup process, then the dynamic workload steering client 301 can send a request for directives to the dynamic workload steering agent 303. If the entry found in the lookup table or similar local storage is ‘restricted,’ then the process lacks permissions to process the request and the request can be rejected (Block 1513). If an entry is found in the lookup table or similar cache, then the accelerator is selected based on the information in the entry. The workload can then be forwarded to the identified processor and/or accelerator. The data parallel task is executed (Block 1508), the execution result is provided to the application via the results buffer (Block 1509) and analytics information is sent to the dynamic workload steering agent 303 (Block 1511).

### Workload Steering Decisions

Accelerator selection for specific data parallel tasks can be implemented using many different algorithms. The selection can be done by the dynamic workload steering agent 303 based on collected and received insights and analytics information with the target of satisfying optimization targets received during the subscription. The analytics information might include timing (execution time, queueing time, data transfer time), energy consumption, execution frequency, amount of input and output data and related throughput. The insights might include the complexity of tasks (number of loops, nested loops, different memory access instructions, amount of work memory needed, number of computation groups) and other information relevant to accelerator selection. In an example embodiment, more complex algorithms can be applied, including some of the solutions mentioned herein.

In some embodiments, the accelerator selection algorithm balances the execution time of data parallel tasks and the related energy consumption. Analytics information are collected including the measured execution time (latency) of data parallel tasks in dynamic workload steering clients (provided to the dynamic workload steering agent as Workload Runtime Analytics) and measure energy consumption directly or indirectly in the dynamic workload steering agent.

An optimization target can be defined as a weighted sum of the normalized metrics for each accelerator:

$${Score}_{accelerator 1} = {w}_{latency} \frac{{t}_{accelerator 1}}{max ( t )} + {w}_{energy} \frac{{e}_{accelerator 1}}{max ( e )}$$

With weights as:

$${w}_{latency} + {w}_{energy} = 1$$

In this example embodiment, the targeting of the selection of the accelerator is with the lowest score for each data parallel task. For example, if for the given application subscription, latency is critical at the price of possibly higher energy consumption, the value of W_{latency} is set to 1, or close to 1. For appropriate accelerator selection, the score needs to be calculated for every accelerator available for the accelerated application.

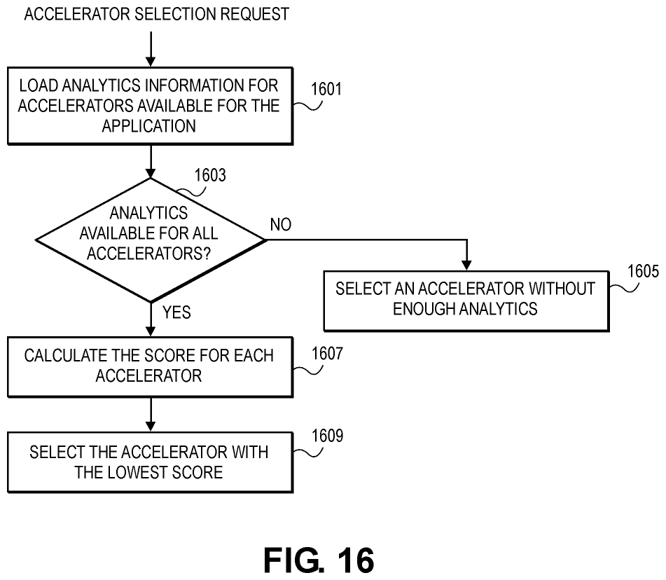

FIG. 16 is a flowchart of one embodiment of a process for accelerator selection. While analytics information is collected by the dynamic workload steering client 301 and the dynamic workload steering agent 303, historical values can be also received from the dynamic workload steering server 305. If analytics are missing for a certain accelerator, it is the task of the dynamic workload steering agent 303 to select the accelerator and gather information.

In some embodiments, the dynamic workload steering agent 303 can use different insights for decision making. The workload complexity, organization of computation loops or memory access patterns may indicate that the given data parallel task is not suitable for certain accelerators. For example, a task may take unreasonably long to be executed on CPU. In this case certain accelerators might be removed from the list of possible options even without analytics information available.

The accelerator selection process can be triggered by the accelerator selection request. The dynamic workload steering agent 303 loads analytics information for accelerators available for the application identified in the request (Block 1601). A determination is made whether there are analytics available for all of the available accelerators (Block 1603). If analytics are not available for all of the accelerators, then an accelerator is selected with the limited analytics available (Block 1605). If analytics are available for all of the available processors, then a score is generated for each accelerator (Block 1607). The accelerator with the best score (e.g., the lowest) can then be selected for the given task and application (Block 1609).

In some embodiments, machine learning models can be applied during the selection process. For example, a machine learning model can be trained to approximate execution analytics based on task complexity parameters. Such machine learning models can be trained by the dynamic workload steering server 305 based on aggregated historical information from the dynamic workload steering agents 303. After the training, the model can be provided to the dynamic workload steering agents 303 that can use the model during the accelerator selection method.

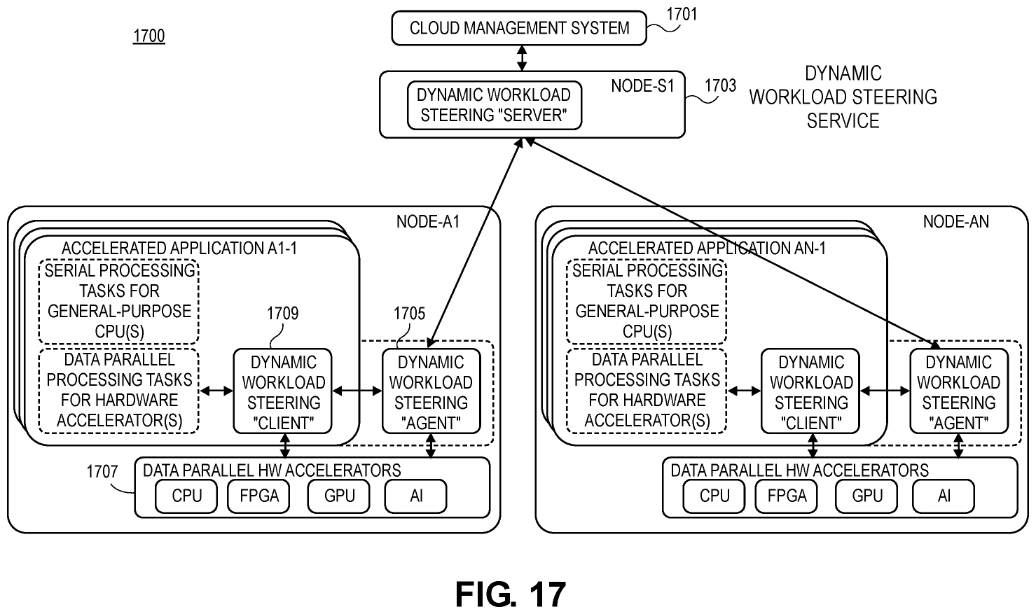

FIG. 17 is a diagram of one example of a cloud system in which the dynamic workload steering service can operate. In the context of cloud systems, cloud orchestration systems can utilize and benefit from dynamic workload steering service to select the most appropriate accelerator to allocate to each accelerated application. The cloud infrastructure can implement the means to monitor the performance of accelerated applications on allocated hardware accelerators. This can include collecting the analytics across multiple computing nodes at the dynamic workload steering server that can then be distributed to the dynamic workload steering agents in the system. In combination with the dynamic workload steering service data can be collected and analyzed to select the best processor such as an accelerator or general-purpose processor for a workload of an accelerated application.

In the embodiments, the accelerator selection process is implemented as part of a dynamic workload steering service in the cloud system 1700. The cloud system 1700 can include a cloud management system 1701, and a set of compute nodes S1 and A1-An. A dynamic workload steering server 1703 is deployed on Node-S1. In some embodiments, the dynamic workload steering server 1703 can be deployed on a set of nodes forming a cluster. The dynamic workload steering server 1703 manages the overall coordination of the applications in the cloud system. The accelerated applications are assigned to computing nodes (e.g., A1 and AN) in the bottom part of the figure, which also shows that a dynamic workload steering agent 1705 can serve multiple accelerated application (e.g., A1-1) on a given node (e.g., A1) and also that multiple dynamic workload agents 1705 can report to a single dynamic workload server 1703. The dynamic workload steering agents 1705 provide the locally collected analytics information to the dynamic workload steering server 1703. As a result, if a given accelerated application is deployed multiple times in the cloud system 1700, the dynamic workload steering server 1703 can provide historical analytics information to support the workload steering decisions in the dynamic workload steering agents 1705.

Each accelerated application (e.g., A1-1) can include a dynamic workload steering client 1709. The dynamic workload steering client 1709 can provide insights to the dynamic workload steering agent 1705 and similarly manage the communication between the application and the dynamic workload steering services that includes the accelerator selection process that determines which of the available hardware accelerators 1707 each application and/or application kernel is assigned to for execution. Each compute node (e.g., A1) can include any number and variety of hardware accelerators 1707 to which any number and combination of accelerated applications and associated kernels can be assigned to for execution.

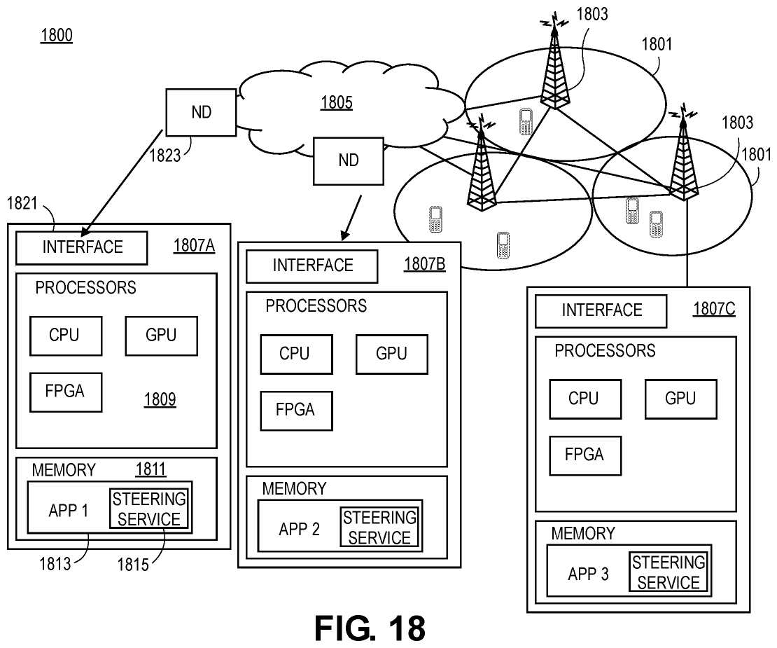

FIG. 18 is a diagram of one embodiment of a mobile communication network including resources that form an edge cloud system. The mobile communication network 1800 can include a core network 1805 and a set of radio access networks (RANs) 1807. The RANs 1807 consist of a set of base stations that provide connectivity to a set of user equipment (UEs) such as mobile devices (i.e., cellular phones). A base station 1803 can service and provide connectivity to any number of UEs. The base station 1803 can enable communication between UEs and other UEs or the core network 1805. Each base station 1803 can provide a set of compute resources 1807C. The compute resources can include a communication interface, processors including hardware accelerators (e.g., CPUs, GPUs, FPGAs, and similar accelerators) and similar components. The base station 1803 can also include storage including dynamic memory, static memory, long term storage media, and similar components. The base station memory can be a set of memory devices that form a larger memory and/or storage system. In some embodiments, the memory can be divided amongst the available processors with certain accelerators utilizing dedicated memory components and/or storage. The accelerated applications can be stored in and/or operate in these memory devices after deployment and during run time. Similarly, the components of the dynamic workload steering service including the accelerator selection process can be stored in this memory.

The core network 1805 can also include computing nodes such as computing nodes 1807A-B that can form part of a centralized cloud system or an edge cloud system. These computing nodes 1807A-B can similarly include communication interfaces 1815, processors 1809, memory 1811, and similar components. The interface 1815 can be any type of networking interface for wired or wireless communication. Any number or variety of processors including CPUs, GPUs, FPGAs, and similar processing devices and accelerators can be included in the processors 1809. The computing nodes 1807A-B can also include memory/storage 1811 including dynamic memory, static memory, long term storage media, and similar components. The base station memory can be a set of memory devices that form a larger memory and/or storage system. In some embodiments, the memory 1811 can be divided amongst the available processors with certain accelerators utilizing dedicated memory components and/or storage. The accelerated applications 1813 can be stored in and/or operate in these memory devices after deployment and during run time. Similarly, the components of the dynamic workload steering service 1815 including the accelerator selection process can be stored in this memory.

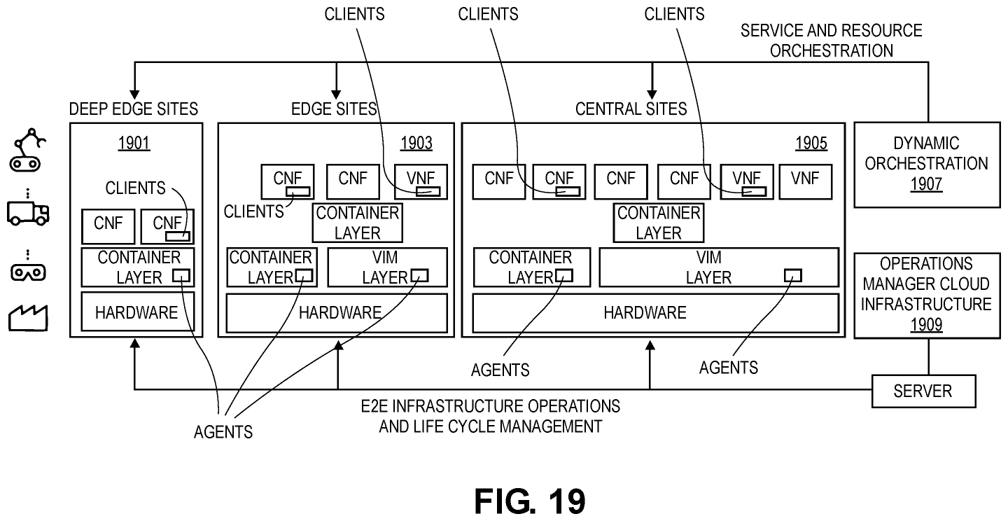

FIG. 19 is a diagram of one embodiment of a cloud system that includes edge cloud resources and centralized cloud resources. In this embodiment, the dynamic workload steering system is implemented in a distributed cloud system than includes edge cloud sites 1901, 1903 (e.g., a deep edge site 1901 and standard edge site 1903), central cloud site 1905 and management components 1907, 1909. Deep edge sites 1901 are further removed and have fewer resources than an edge site 1903.

The deep edge sites 1901 are positioned closest to UEs and include a hardware layer with any number of general-purpose processors and accelerators. A container layer such as Docker, Kubernetes, or similar system can execute over the hardware layer to support application execute where the support any number of applications or functions running in containers. The applications and functions can be executed as cloud-native network functions (CNFs), virtualized network functions (VNFs), or similar containerized functions. Where dynamic workload steering is supported, the applications in the CNFs, VNFs or similar containerized functions can include agents of the dynamic workload steering service. Similarly, the dynamic workload steering service agents can service the clients from the container layer. The dynamic workload service agents can coordinate with dynamic workload service servers, which can be a part of or adjacent to the dynamic orchestration 1907, cloud management infrastructure 1909, operations manager cloud infrastructure 1909, or similar part of the cloud management.

The edge sites 1903 are positioned close to UEs and include a hardware layer with any number of general-purpose processors and accelerators. A container layer such as Docker, Kubernetes, or similar system can execute over the hardware layer to support application execute where the support any number of applications or functions running in containers. A virtualized infrastructure manager (VIM) is present to support VNFs. In some embodiments, a container layer can run over the VIM layer. The applications and functions can be executed as CNFs, VNFs, or similar containerized functions. Where dynamic workload steering is supported, the applications in the CNFs, VNFs or similar containerized functions can include agents of the dynamic workload steering service. Similarly, the dynamic workload steering service agents can service the clients from the container layer. The dynamic workload service agents can coordinate with dynamic workload service servers, which can be a part of or adjacent to the dynamic orchestration 1907, cloud management infrastructure 1909, operations manager cloud infrastructure 1909, or similar part of the cloud management.

The centralized sites 1905 are positioned close to the core of a mobile communication network and include a hardware layer with any number of general-purpose processors and accelerators. A container layer such as Docker, Kubernetes, or similar system can execute over the hardware layer to support application execute where the support any number of applications or functions running in containers. A virtualized infrastructure manager (VIM) is present to support VNFs. In some embodiments, a container layer can run over the VIM layer. The applications and functions can be executed as CNFs, VNFs, or similar containerized functions. Where dynamic workload steering is supported, the applications in the CNFs, VNFs or similar containerized functions can include agents of the dynamic workload steering service. Similarly, the dynamic workload steering service agents can service the clients from the container layer. The dynamic workload service agents can coordinate with dynamic workload service servers, which can be a part of or adjacent to the dynamic orchestration 1907, cloud management infrastructure 1909, operations manager cloud infrastructure 1909, or similar part of the cloud management.

The dynamic orchestration component 1907 can manage the deployment and handling of the CNF, VNF, and similar containerized functions. The operation manager cloud infrastructure 1909 can manage the hardware, container layer, VIM, and related aspects of the cloud system. In some embodiments, the dynamic workload steering service server is supported by or a component of the operations manager cloud infrastructure.

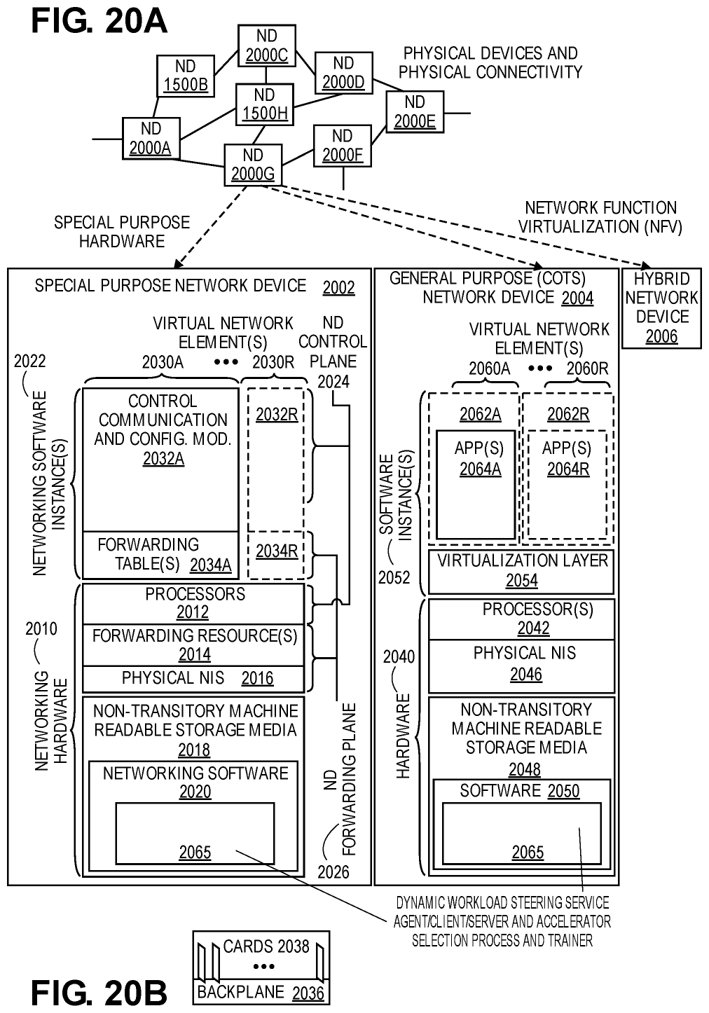

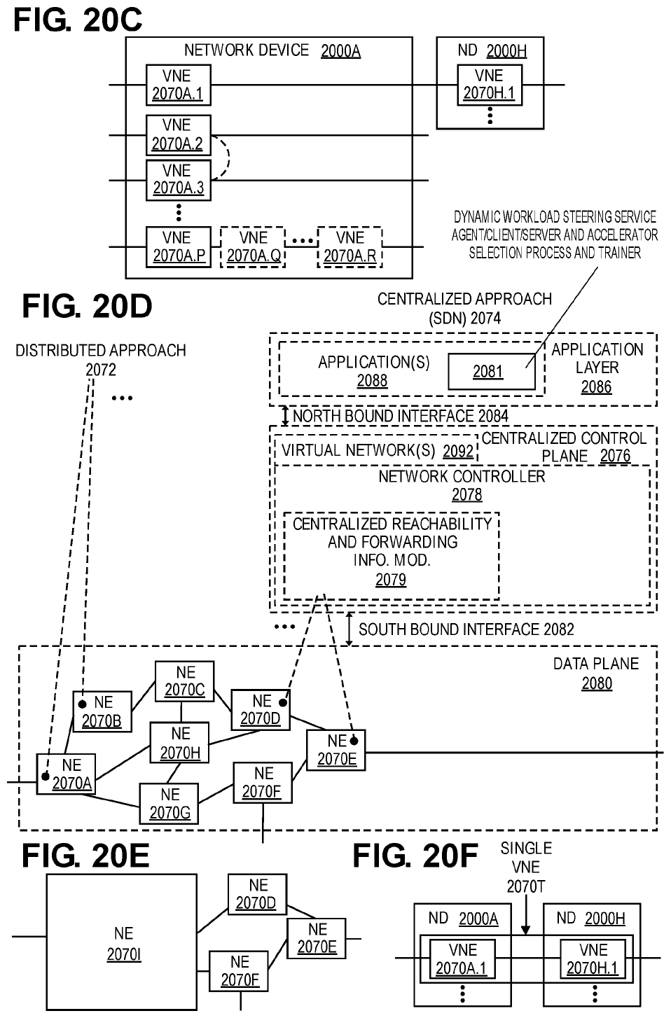

FIG. 20A illustrates connectivity between network devices (NDs) within an exemplary network, as well as three exemplary implementations of the NDs, according to some embodiments. FIG. 20A shows NDs 2000A-H, and their connectivity by way of lines between 2000A-2000B, 2000B-2000C, 2000C-2000D, 2000D-2000E, 2000E-2000F, 2000F-2000G, and 2000A-2000G, as well as between 2000H and each of 2000A, 2000C, 2000D, and 2000G. These NDs are physical devices, and the connectivity between these NDs can be wireless or wired (often referred to as a link). An additional line extending from NDs 2000A, 2000E, and 2000F illustrates that these NDs act as ingress and egress points for the network (and thus, these NDs are sometimes referred to as edge NDs; while the other NDs may be called core NDs).

Two of the exemplary ND implementations in FIG. 20A are: 1) a special-purpose network device 2002 that uses custom application-specific integrated-circuits (ASICs) and a special-purpose operating system (OS); and 2) a general purpose network device 2004 that uses common off-the-shelf (COTS) processors and a standard OS.

The special-purpose network device 2002 includes networking hardware 2010 comprising a set of one or more processor(s) 2012, forwarding resource(s) 2014 (which typically include one or more ASICs and/or network processors), and physical network interfaces (NIs) 2016 (through which network connections are made, such as those shown by the connectivity between NDs 2000A-H), as well as non-transitory machine readable storage media 2018 having stored therein networking software 2020. During operation, the networking software 2020 may be executed by the networking hardware 2010 to instantiate a set of one or more networking software instance(s) 2022. Each of the networking software instance(s) 2022, and that part of the networking hardware 2010 that executes that network software instance (be it hardware dedicated to that networking software instance and/or time slices of hardware temporally shared by that networking software instance with others of the networking software instance(s) 2022), form a separate virtual network element 2030A-R. Each of the virtual network element(s) (VNEs) 2030A-R includes a control communication and configuration module 2032A-R (sometimes referred to as a local control module or control communication module) and forwarding table(s) 2034A-R, such that a given virtual network element (e.g., 2030A) includes the control communication and configuration module (e.g., 2032A), a set of one or more forwarding table(s) (e.g., 2034A), and that portion of the networking hardware 2010 that executes the virtual network element (e.g., 2030A).

The networking software 2020 can include the dynamic workload steering service agent, client, and/or server 2065 depending on the configuration and operation of the special-purpose network device 2002 in the overall network. The networking software 2020 can also include the accelerator selection process, AI trainer, and related components 2065 as part of the dynamic workload steering service.

The special-purpose network device 2002 is often physically and/or logically considered to include: 1) a ND control plane 2024 (sometimes referred to as a control plane) comprising the processor(s) 2012 that execute the control communication and configuration module(s) 2032A-R; and 2) a ND forwarding plane 2026 (sometimes referred to as a forwarding plane, a data plane, or a media plane) comprising the forwarding resource(s) 2014 that utilize the forwarding table(s) 2034A-R and the physical NIs 2016. By way of example, where the ND is a router (or is implementing routing functionality), the ND control plane 2024 (the processor(s) 2012 executing the control communication and configuration module(s) 2032A-R) is typically responsible for participating in controlling how data (e.g., packets) is to be routed (e.g., the next hop for the data and the outgoing physical NI for that data) and storing that routing information in the forwarding table(s) 2034A-R, and the ND forwarding plane 2026 is responsible for receiving that data on the physical NIs 2016 and forwarding that data out the appropriate ones of the physical NIs 2016 based on the forwarding table(s) 2034A-R.

FIG. 20B illustrates an exemplary way to implement the special-purpose network device 2002 according to some embodiments. FIG. 20B shows a special-purpose network device including cards 2038 (typically hot pluggable). While in some embodiments the cards 2038 are of two types (one or more that operate as the ND forwarding plane 2026 (sometimes called line cards), and one or more that operate to implement the ND control plane 2024 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 2036 (e.g., a first full mesh coupling the line cards and a second full mesh coupling all of the cards).

Returning to FIG. 20A, the general purpose network device 2004 includes hardware 2040 comprising a set of one or more processor(s) 2042 (which are often COTS processors) and physical NIs 2046, as well as non-transitory machine readable storage media 2048 having stored therein software 2050. During operation, the processor(s) 2042 execute the software 2050 to instantiate one or more sets of one or more applications 2064A-R. While one embodiment does not implement virtualization, alternative embodiments may use different forms of virtualization. For example, in one such alternative embodiment the virtualization layer 2054 represents the kernel of an operating system (or a shim executing on a base operating system) that allows for the creation of multiple instances 2062A-R called software containers that may each be used to execute one (or more) of the sets of applications 2064A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 2054 represents a hypervisor (sometimes referred to as a virtual machine monitor (VMM)) or a hypervisor executing on top of a host operating system, and each of the sets of applications 2064A-R is run on top of a guest operating system within an instance 2062A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 2040, directly on a hypervisor (in which case the unikernel is sometimes described as running within a LibOS virtual machine), or in a software container, embodiments can be implemented fully with unikernels running directly on a hypervisor represented by virtualization layer 2054, unikernels running within software containers represented by instances 2062A-R, or as a combination of unikernels and the above-described techniques (e.g., unikernels and virtual machines both run directly on a hypervisor, unikernels and sets of applications that are run in different software containers).

The software 2050 can include the dynamic workload steering service agent, client, and/or server 2065 depending on the configuration and operation of the general purpose network device 2004 in the overall network. The software 2050 can also include the accelerator selection process, AI trainer, and related components 2065 as part of the dynamic workload steering service.

The instantiation of the one or more sets of one or more applications 2064A-R, as well as virtualization if implemented, are collectively referred to as software instance(s) 2052. Each set of applications 2064A-R, corresponding virtualization construct (e.g., instance 2062A-R) if implemented, and that part of the hardware 2040 that executes them (be it hardware dedicated to that execution and/or time slices of hardware temporally shared), forms a separate virtual network element(s) 2060A-R.

The virtual network element(s) 2060A-R perform similar functionality to the virtual network element(s) 2030A-R—e.g., similar to the control communication and configuration module(s) 2032A and forwarding table(s) 2034A (this virtualization of the hardware 2040 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments are illustrated with each instance 2062A-R corresponding to one VNE 2060A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 2062A-R to VNEs also apply to embodiments where such a finer level of granularity and/or unikernels are used.

In certain embodiments, the virtualization layer 2054 includes a virtual switch that provides similar forwarding services as a physical Ethernet switch. Specifically, this virtual switch forwards traffic between instances 2062A-R and the physical NI(s) 2046, as well as optionally between the instances 2062A-R; in addition, this virtual switch may enforce network isolation between the VNEs 2060A-R that by policy are not permitted to communicate with each other (e.g., by honoring virtual local area networks (VLANs)).

The third exemplary ND implementation in FIG. 20A is a hybrid network device 2006, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 2002) could provide for para-virtualization to the networking hardware present in the hybrid network device 2006.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also, in all of the above exemplary implementations, each of the VNEs (e.g., VNE(s) 2030A-R, VNEs 2060A-R, and those in the hybrid network device 2006) receives data on the physical NIs (e.g., 2016, 2046) and forwards that data out the appropriate ones of the physical NIs (e.g., 2016, 2046). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 20C illustrates various exemplary ways in which VNEs may be coupled according to some embodiments. FIG. 20C shows VNEs 2070A.1-2070A.P (and optionally VNEs 2070A.Q-2070A.R) implemented in ND 2000A and VNE 2070H.1 in ND 2000H. In FIG. 20C, VNEs 2070A.1-P are separate from each other in the sense that they can receive packets from outside ND 2000A and forward packets outside of ND 2000A; VNE 2070A.1 is coupled with VNE 2070H.1, and thus they communicate packets between their respective NDs; VNE 2070A.2-2070A.3 may optionally forward packets between themselves without forwarding them outside of the ND 2000A; and VNE 2070A.P may optionally be the first in a chain of VNEs that includes VNE 2070A.Q followed by VNE 2070A.R (this is sometimes referred to as dynamic service chaining, where each of the VNEs in the series of VNEs provides a different service—e.g., one or more layer 4-7 network services). While FIG. 20C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 20A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 20A may also host one or more such servers (e.g., in the case of the general purpose network device 2004, one or more of the software instances 2062A-R may operate as servers; the same would be true for the hybrid network device 2006; in the case of the special-purpose network device 2002, one or more such servers could also be run on a virtualization layer executed by the processor(s) 2012); in which case the servers are said to be co-located with the VNEs of that ND.

A virtual network is a logical abstraction of a physical network (such as that in FIG. 20A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 20D illustrates a network with a single network element on each of the NDs of FIG. 20A, and within this straightforward approach contrasts a traditional distributed approach (commonly used by traditional routers) with a centralized approach for maintaining reachability and forwarding information (also called network control), according to some embodiments. Specifically, FIG. 20D illustrates network elements (NEs) 2070A-H with the same connectivity as the NDs 2000A-H of FIG. 20A.

FIG. 20D illustrates that the distributed approach 2072 distributes responsibility for generating the reachability and forwarding information across the NEs 2070A-H; in other words, the process of neighbor discovery and topology discovery is distributed.

For example, where the special-purpose network device 2002 is used, the control communication and configuration module(s) 2032A-R of the ND control plane 2024 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 2070A-H (e.g., the processor(s) 2012 executing the control communication and configuration module(s) 2032A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 2024. The ND control plane 2024 programs the ND forwarding plane 2026 with information (e.g., adjacency and route information) based on the routing structure(s). For example, the ND control plane 2024 programs the adjacency and route information into one or more forwarding table(s) 2034A-R (e.g., Forwarding Information Base (FIB), Label Forwarding Information Base (LFIB), and one or more adjacency structures) on the ND forwarding plane 2026. For layer 2 forwarding, the ND can store one or more bridging tables that are used to forward data based on the layer 2 information in that data. While the above example uses the special-purpose network device 2002, the same distributed approach 2072 can be implemented on the general purpose network device 2004 and the hybrid network device 2006.

FIG. 20D illustrates that a centralized approach 2074 (also known as software defined networking (SDN)) that decouples the system that makes decisions about where traffic is sent from the underlying systems that forwards traffic to the selected destination. The illustrated centralized approach 2074 has the responsibility for the generation of reachability and forwarding information in a centralized control plane 2076 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 2076 has a south bound interface 2082 with a data plane 2080 (sometime referred to the infrastructure layer, network forwarding plane, or forwarding plane (which should not be confused with a ND forwarding plane)) that includes the NEs 2070A-H (sometimes referred to as switches, forwarding elements, data plane elements, or nodes). The centralized control plane 2076 includes a network controller 2078, which includes a centralized reachability and forwarding information module 2079 that determines the reachability within the network and distributes the forwarding information to the NEs 2070A-H of the data plane 2080 over the south bound interface 2082 (which may use the OpenFlow protocol). Thus, the network intelligence is centralized in the centralized control plane 2076 executing on electronic devices that are typically separate from the NDs.

For example, where the special-purpose network device 2002 is used in the data plane 2080, each of the control communication and configuration module(s) 2032A-R of the ND control plane 2024 typically include a control agent that provides the VNE side of the south bound interface 2082. In this case, the ND control plane 2024 (the processor(s) 2012 executing the control communication and configuration module(s) 2032A-R) performs its responsibility for participating in controlling how data (e.g., packets) is to be routed (e.g., the next hop for the data and the outgoing physical NI for that data) through the control agent communicating with the centralized control plane 2076 to receive the forwarding information (and in some cases, the reachability information) from the centralized reachability and forwarding information module 2079 (it should be understood that in some embodiments, the control communication and configuration module(s) 2032A-R, in addition to communicating with the centralized control plane 2076, may also play some role in determining reachability and/or calculating forwarding information-albeit less so than in the case of a distributed approach; such embodiments are generally considered to fall under the centralized approach 2074, but may also be considered a hybrid approach).

While the above example uses the special-purpose network device 2002, the same centralized approach 2074 can be implemented with the general purpose network device 2004 (e.g., each of the VNE 2060A-R performs its responsibility for controlling how data (e.g., packets) is to be routed (e.g., the next hop for the data and the outgoing physical NI for that data) by communicating with the centralized control plane 2076 to receive the forwarding information (and in some cases, the reachability information) from the centralized reachability and forwarding information module 2079; it should be understood that in some embodiments, the VNEs 2060A-R, in addition to communicating with the centralized control plane 2076, may also play some role in determining reachability and/or calculating forwarding information-albeit less so than in the case of a distributed approach) and the hybrid network device 2006. In fact, the use of SDN techniques can enhance the NFV techniques typically used in the general purpose network device 2004 or hybrid network device 2006 implementations as NFV is able to support SDN by providing an infrastructure upon which the SDN software can be run, and NFV and SDN both aim to make use of commodity server hardware and physical switches.

FIG. 20D also shows that the centralized control plane 2076 has a north bound interface 2084 to an application layer 2086, in which resides application(s) 2088. The centralized control plane 2076 has the ability to form virtual networks 2092 (sometimes referred to as a logical forwarding plane, network services, or overlay networks (with the NEs 2070A-H of the data plane 2080 being the underlay network)) for the application(s) 2088. Thus, the centralized control plane 2076 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

The application layer 2086 can include the dynamic workload steering service agent, client, and/or server 2081 depending on the configuration and operation of the centralized approach 2074. The application layer 2086 can also include the accelerator selection process, AI trainer, and related components 2081 as part of the dynamic workload steering service.

While FIG. 20D shows the distributed approach 2072 separate from the centralized approach 2074, the effort of network control may be distributed differently or the two combined in certain embodiments. For example: 1) embodiments may generally use the centralized approach (SDN) 2074, but have certain functions delegated to the NEs (e.g., the distributed approach may be used to implement one or more of fault monitoring, performance monitoring, protection switching, and primitives for neighbor and/or topology discovery); or 2) embodiments may perform neighbor discovery and topology discovery via both the centralized control plane and the distributed protocols, and the results compared to raise exceptions where they do not agree. Such embodiments are generally considered to fall under the centralized approach 2074 but may also be considered a hybrid approach.

While FIG. 20D illustrates the simple case where each of the NDs 2000A-H implements a single NE 2070A-H, it should be understood that the network control approaches described with reference to FIG. 20D also work for networks where one or more of the NDs 2000A-H implement multiple VNEs (e.g., VNEs 2030A-R, VNEs 2060A-R, those in the hybrid network device 2006). Alternatively, or in addition, the network controller 2078 may also emulate the implementation of multiple VNEs in a single ND. Specifically, instead of (or in addition to) implementing multiple VNEs in a single ND, the network controller 2078 may present the implementation of a VNE/NE in a single ND as multiple VNEs in the virtual networks 2092 (all in the same one of the virtual network(s) 2092, each in different ones of the virtual network(s) 2092, or some combination). For example, the network controller 2078 may cause an ND to implement a single VNE (a NE) in the underlay network, and then logically divide up the resources of that NE within the centralized control plane 2076 to present different VNEs in the virtual network(s) 2092 (where these different VNEs in the overlay networks are sharing the resources of the single VNE/NE implementation on the ND in the underlay network).

On the other hand, FIGS. 20E and 20F respectively illustrate exemplary abstractions of NEs and VNEs that the network controller 2078 may present as part of different ones of the virtual networks 2092. FIG. 20E illustrates the simple case of where each of the NDs 2000A-H implements a single NE 2070A-H (see FIG. 20D), but the centralized control plane 2076 has abstracted multiple of the NEs in different NDs (the NEs 2070A-C and G-H) into (to represent) a single NE 2070I in one of the virtual network(s) 2092 of FIG. 20D, according to some embodiments. FIG. 20E shows that in this virtual network, the NE 2070I is coupled to NE 2070D and 2070F, which are both still coupled to NE 2070E.

FIG. 20F illustrates a case where multiple VNEs (VNE 2070A.1 and VNE 2070H.1) are implemented on different NDs (ND 2000A and ND 2000H) and are coupled to each other, and where the centralized control plane 2076 has abstracted these multiple VNEs such that they appear as a single VNE 2070T within one of the virtual networks 2092 of FIG. 20D, according to some embodiments. Thus, the abstraction of a NE or VNE can span multiple NDs.

While some embodiments implement the centralized control plane 2076 as a single entity (e.g., a single instance of software running on a single electronic device), alternative embodiments may spread the functionality across multiple entities for redundancy and/or scalability purposes (e.g., multiple instances of software running on different electronic devices).

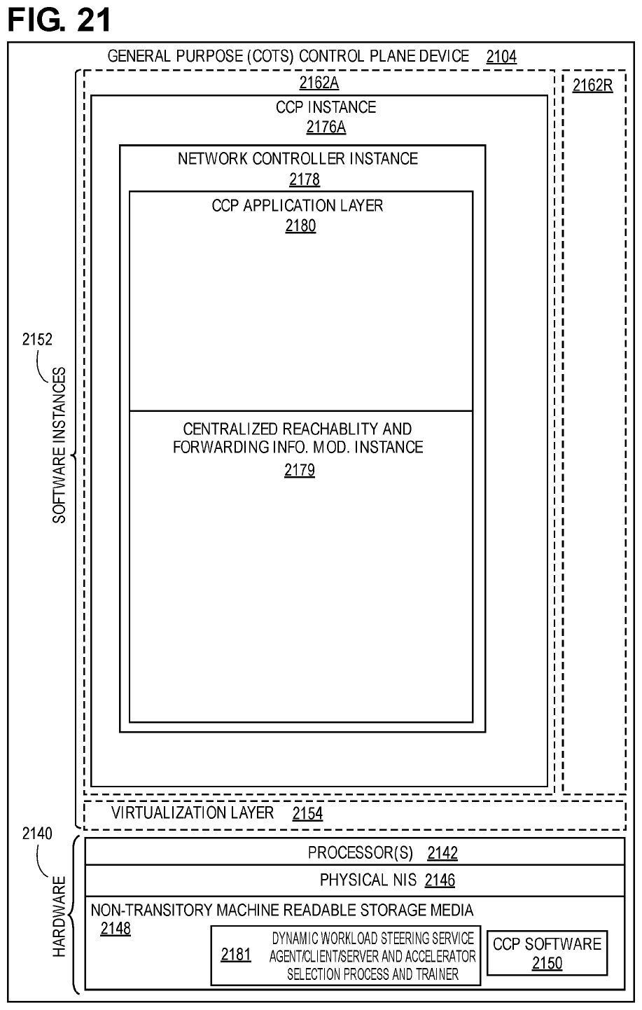

Similar to the network device implementations, the electronic device(s) running the centralized control plane 2076, and thus the network controller 2078 including the centralized reachability and forwarding information module 2079, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 21 illustrates, a general purpose control plane device 2104 including hardware 2140 comprising a set of one or more processor(s) 2142 (which are often COTS processors) and physical NIs 2146, as well as non-transitory machine readable storage media 2148 having stored therein centralized control plane (CCP) software 2150.

The non-transitory machine readable storage medium 2148 can include the dynamic workload steering service agent, client, and/or server 2181 depending on the configuration and operation of the general purpose control plane device 2104 in the overall network. The storage medium 2148 can also include the accelerator selection process, AI trainer, and related components 2181 as part of the dynamic workload steering service.

In embodiments that use compute virtualization, the processor(s) 2142 typically execute software to instantiate a virtualization layer 2154 (e.g., in one embodiment the virtualization layer 2154 represents the kernel of an operating system (or a shim executing on a base operating system) that allows for the creation of multiple instances 2162A-R called software containers (representing separate user spaces and also called virtualization engines, virtual private servers, or jails) that may each be used to execute a set of one or more applications; in another embodiment the virtualization layer 2154 represents a hypervisor (sometimes referred to as a virtual machine monitor (VMM)) or a hypervisor executing on top of a host operating system, and an application is run on top of a guest operating system within an instance 2162A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 2140, directly on a hypervisor represented by virtualization layer 2154 (in which case the unikernel is sometimes described as running within a LibOS virtual machine), or in a software container represented by one of instances 2162A-R). Again, in embodiments where compute virtualization is used, during operation an instance of the CCP software 2150 (illustrated as CCP instance 2176A) is executed (e.g., within the instance 2162A) on the virtualization layer 2154. In embodiments where compute virtualization is not used, the CCP instance 2176A is executed, as a unikernel or on top of a host operating system, on the “bare metal” general purpose control plane device 2104. The instantiation of the CCP instance 2176A, as well as the virtualization layer 2154 and instances 2162A-R if implemented, are collectively referred to as software instance(s) 2152.

In some embodiments, the CCP instance 2176A includes a network controller instance 2178. The network controller instance 2178 includes a centralized reachability and forwarding information module instance 2179 (which is a middleware layer providing the context of the network controller 2078 to the operating system and communicating with the various NEs), and an CCP application layer 2180 (sometimes referred to as an application layer) over the middleware layer (providing the intelligence required for various network operations such as protocols, network situational awareness, and user-interfaces). At a more abstract level, this CCP application layer 2180 within the centralized control plane 2076 works with virtual network view(s) (logical view(s) of the network) and the middleware layer provides the conversion from the virtual networks to the physical view.

The centralized control plane 2076 transmits relevant messages to the data plane 2080 based on CCP application layer 2180 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 2080 may receive different messages, and thus different forwarding information. The data plane 2080 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPV4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 2080, the packet (or a subset of the packet header and content) is typically forwarded to the centralized control plane 2076. The centralized control plane 2076 will then program forwarding table entries into the data plane 2080 to accommodate packets belonging to the flow of the unknown packet. Once a specific forwarding table entry has been programmed into the data plane 2080 by the centralized control plane 2076, the next packet with matching credentials will match that forwarding table entry and take the set of actions associated with that matched entry.

While the dynamic workload steering service has been described in terms of several embodiments, those skilled in the art will recognize that the dynamic workload steering service is not limited to the embodiments described, can be practiced with modification and alteration within the spirit and scope of the appended claims. The description is thus to be regarded as illustrative instead of limiting.

1. A method for determining accelerators to execute a function of an application in a computing node, the application including a workload steering client, the method comprising:
receiving, by the workload steering client, a workload request from the application identifying a first task;
determining, by the workload steering client, whether the first task has an assigned accelerator;
requesting, by the workload steering client, the first task to be executed on the assigned accelerator; and
returning, by the workload steering client, a result of the first task to the application.

2. The method of claim 1, further comprising:
sending, by the workload steering client, a request for directives to a workload steering agent, in response to not finding the assigned accelerator.

3. The method of claim 2, further comprising:
receiving, by the workload steering agent, the request for directives from the workload steering client identifying the application;
retrieving, by the workload steering agent, application subscription information for the application; and
selecting, by the workload steering agent, an accelerator for the request based on the application subscription information.

4. The method of claim 3, further comprising:
allocating and validating, by the workload steering agent, the selected accelerator for the request; and
sending, by the workload steering agent, a workload steering directive to the workload steering client.

5. The method of claim 4, further comprising:
collecting, by the workload steering agent, workload runtime analytics from the workload steering client;
collecting, by the workload steering agent, application and accelerator insights and analytics from a workload steering server; and
collecting, by the workload steering agent, accelerator analytics from each accelerator in the computing node.

6. The method of claim 5, further comprising:
calculating, by the workload steering agent, a score for each accelerator based on the workload runtime analytics, application and accelerator insights and analytics, and accelerator analytics; and
selecting, by the workload steering agent, the accelerator with a best score for the first task.

7. The method of claim 5, further comprising:
sending, by the workload steering client, a registration for the application to the workload steering agent; and
requesting, by the workload steering agent, an application service profile for the application, from the workload steering server.

8. The method of claim 7, wherein the registration includes an application identifier, and a list of accelerators.

9. The method of claim 7, wherein the application service profile includes an application identifier, task identifier, a list of accelerators, a list of targets, and analytics.

10. The method of claim 4, wherein the workload steering directive includes a registration identifier, a task identifier, and a list of accelerators.

11. A non-transitory machine-readable medium having stored therein computer program code which when executed by a computer system causes the computer system to carry out operations comprising:
receiving, by a workload steering client, a workload request from an application identifying a first task;
determining, by the workload steering client, whether the first task has an assigned accelerator;
requesting, by the workload steering client, the first task to be executed on the assigned accelerator; and
returning, by the workload steering client, a result of the first task to the application.

12. A computing node comprising:
a machine-readable storage medium having stored therein, an application, a workload steering client, a workload steering agent, and a workload steering server; and
a set of processors including general purpose processors and accelerators to execute the application, the workload steering client, the workload steering agent, and the workload steering server, and the application to:
receive, by the workload steering client, a workload request from the application identifying a first task;
determine, by the workload steering client, whether the first task has an assigned accelerator;
request, by the workload steering client, the first task to be executed on the assigned accelerator; and
return, by the workload steering client, a result of the first task to the application.

13. The non-transitory machine-readable medium of claim 11 having stored therein further computer program code which when executed by the computer system causes the computer system to carry out further operations comprising:
sending, by the workload steering client, a request for directives to a workload steering agent, in response to not finding the assigned accelerator.

14. The non-transitory machine-readable medium of claim 13 having stored therein further computer program code which when executed by the computer system causes the computer system to carry out further operations comprising:
receiving, by the workload steering agent, the request for directives from the workload steering client identifying the application;
retrieving, by the workload steering agent, application subscription information for the application; and
selecting, by the workload steering agent, an accelerator for the request based on the application subscription information.

15. The non-transitory machine-readable medium of claim 14 having stored therein further computer program code which when executed by the computer system causes the computer system to carry out further operations comprising:
allocating and validating, by the workload steering agent, the selected accelerator for the request; and
sending, by the workload steering agent, a workload steering directive to the workload steering client.

16. The non-transitory machine-readable medium of claim 15 having stored therein further computer program code which when executed by the computer system causes the computer system to carry out further operations comprising:
collecting, by the workload steering agent, workload runtime analytics from the workload steering client;
collecting, by the workload steering agent, application and accelerator insights and analytics from a workload steering server; and
collecting, by the workload steering agent, accelerator analytics from each accelerator.

17. The computing node of claim 12, wherein the workload steering client is further to send a request for directives to a workload steering agent, in response to not finding the assigned accelerator.

18. The computing node of claim 17, wherein the workload steering agent further to receive the request for directives from the workload steering client identifying the application, retrieve application subscription information for the application, and select an accelerator for the request based on the application subscription information.

19. The computing node of claim 18, wherein the workload steering agent is further to allocate and validate the selected accelerator for the request, and to send a workload steering directive to the workload steering client.

20. The computing node of claim 19, wherein the workload steering agent is further to collect workload runtime analytics from the workload steering client, collect application and accelerator insights and analytics from a workload steering server, and collect accelerator analytics from each accelerator in the computing node.
